(19) United States
(12) Patent Application Publication
(10) Pub. No.: US 2010/0141792 A1
(43) Pub. Date: Jun. 10, 2010

(54) IMAGE CAPTURING APPARATUS AND IMAGE CAPTURING METHOD

(75) Inventor: Kimitaka Arai, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/630,594

(22) Filed: Dec. 3, 2009

(30) Foreign Application Priority Data
Dec. 5, 2008 (JP) 2008-311439

(51) Int. Cl. H04N 5/235

(52) U.S. Cl. 348/229.1; 348/E05.037

(57) ABSTRACT

An image capturing apparatus includes an image capturing unit including a plurality of pixels adjacently disposed in a horizontal direction and a vertical direction and configured to perform photoelectric conversion on received light to accumulate electric charge, and a pixel exposure control unit configured to set an exposure amount of each of the plurality of pixels based on a result of capturing an image by the image capturing unit and to control an exposure time of each of the plurality of pixels.

### BACKGROUND OF THE INVENTION

1. Field of the Invention

The present invention relates to an image capturing apparatus and an image capturing method directed to expanding the dynamic range.

2. Description of the Related Art

In general, the dynamic range of an image sensor used in a digital single-lens reflex camera, compact digital camera, and digital video camera is small as compared to the dynamic range of the real world. Therefore, conventionally, studies have been conducted to expand the dynamic range of the image sensor. Such methods include multiple sampling by taking a plurality of shots, one-shot sampling using a fixed pattern, and exposure time control according to object luminance.

In the method of multiple sampling by taking a plurality of shots, a plurality of images is captured with the exposure time gradually changed to acquire information on the dynamic range. After capturing the images, gain correction is performed on pixel values of each image based on the ratio of the exposure times, and the plurality of captured images is then combined.

One-shot sampling using the fixed pattern is a method for eliminating the time difference between the different exposure shots by preventing a position displacement of a moving object. In the method, a plurality of types of sensitive sensors is disposed on the image sensor, so that a plurality of pieces of exposure information can be acquired in one image capturing. The pixels whose sensitivity has been changed based on the size of an aperture ratio of each pixel and the transmittance of filters are arranged in a fixed pattern to set the sensitivity. As a result, the position displacement caused by the time difference between high sensitivity regions and low sensitivity regions can be improved.

Further, Japanese Patent Application Laid-Open No. 2007-532025 and U.S. Pat. No. 7,362,365 discuss performing exposure time control according to the object luminance by detecting an appropriate exposure amount of a pixel without even once reading out charges. The appropriate exposure amount is detected using an analog/digital converter (ADC) and a comparator, which compares a digital value after conversion and an externally acquired digital value for each pixel.

The method of multiple sampling by taking a plurality of shots results in acquiring a wide dynamic range. However, the position displacement may occur due to the time difference between the shots in the combined image, so that image defects, such as contour blurring and false contour, may occur in the combined image.

Further, in one-shot sampling using a fixed pattern, the high sensitivity regions and the low sensitivity regions become fixed. Therefore, if a luminance range of a scene is wider than the dynamic range that can be captured by the low sensitivity region, it may cause a loss of highlight detail, so that the effect of expanding the dynamic range becomes insufficient. Furthermore, Japanese Patent Application Laid-Open No. 2006-253876 discusses a method of setting the high sensitivity regions and the low sensitivity regions according to the lengths of the exposure time. In such a case, the sensitivity can be set according to the scene. However, since the method sets a sensitivity difference on the sensor by the fixed pattern, sampling points in both the low sensitivity region and the high sensitivity region become less as compared to a conventional RGB sensor. The resolution thus becomes lower. Moreover, by using a fixed pattern regardless of the object luminance, noise increases in a pixel corresponding to the low sensitivity region.

Further, in performing the exposure time control according to the object luminance, it is necessary to compare the charge amounts of all pixels each time the control is performed. It is thus difficult to increase the number of pixels and bits. Furthermore, since the charge generated in the photodiode is continuously transferred to a floating diffusion, the noise generated in the floating diffusion cannot be eliminated, so that noise tolerance is low. Therefore, it is difficult to appropriately expand the dynamic range of the image sensor using the conventional techniques.

### SUMMARY OF THE INVENTION

The present invention is directed to an image capturing apparatus and an image capturing method which are capable of appropriately expanding the dynamic range of an image sensor.

According to an aspect of the present invention, an image capturing apparatus includes an image capturing unit including a plurality of pixels adjacently disposed in a horizontal direction and a vertical direction and configured to perform photoelectric conversion on received light to accumulate electric charge, and a pixel exposure control unit configured to set an exposure amount of each of the plurality of pixels based on a result of capturing an image by the image capturing unit and to control an exposure time of each of the plurality of pixels.

According to another aspect of the present invention, an image capturing method using an image capturing apparatus including a plurality of pixels adjacently disposed in a horizontal direction and a vertical direction and configured to perform photoelectric conversion on received light to accumulate electric charge includes setting an exposure amount of each of the plurality of pixels based on a result of capturing an image by the image capturing unit, controlling an exposure time of each of the plurality of pixels, and performing image capturing using the image capturing unit based on the exposure time.

According to an exemplary embodiment of the present invention, preliminary image capturing is performed using the image capturing unit, and the exposure time is assigned to each pixel based on the result of the preliminary image capturing. Image capturing can thus be performed with a wide dynamic range without a loss of highlight detail and a loss of shadow detail.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a block diagram of a configuration of an image capturing apparatus according to a first exemplary embodiment of the present invention.

FIG. 2 illustrates a flowchart of an operation performed by the image capturing apparatus.

FIGS. 3A and 3B illustrate examples of a dialog window of a boundary luminance parameter setting user interface (UI) displayed in step S201 of the flowchart illustrated in FIG. 2.

FIG. 4 illustrates a state transition diagram for a boundary luminance parameter setting operation.

FIG. 5 illustrates a block diagram of an example of a pixel exposure amount setting unit.

FIG. 6 illustrates a flowchart of details of a re-preliminary image capturing determination operation.

FIG. 7 illustrates an example of recorded image capturing conditions.

FIG. 8 illustrates a flowchart of details of a pixel exposure amount setting operation.

FIG. 9 illustrates a flowchart of details of an exposure time map generation process.

FIG. 10 illustrates a schematic diagram of the exposure time map.

FIG. 11 illustrates a flowchart of details of a drive pulse generation process according to the first exemplary embodiment of the present invention.

FIG. 12 illustrates a schematic diagram of an example of an arrangement of elements configuring a color image sensor unit.

FIG. 13 illustrates a circuit diagram of an example of a pixel structure according to the first exemplary embodiment of the present invention.

FIGS. 14A, 14B, 14C, and 14D illustrate pixel drive methods and characteristics thereof.

FIG. 15 illustrates a flowchart of details of gain calculation.

FIG. 16 illustrates the pixel drive method and characteristics thereof according to a second exemplary embodiment of the present invention.

FIG. 17 illustrates the pixel drive method and characteristics thereof according to a third exemplary embodiment of the present invention.

FIG. 18 illustrates a circuit diagram of an example of a pixel structure according to a fourth exemplary embodiment of the present invention.

FIG. 19 illustrates a pixel drive method and characteristics thereof according to the fourth exemplary embodiment of the present invention.

FIG. 20 illustrates a circuit diagram of an example of a pixel structure according to a fifth exemplary embodiment of the present invention.

FIG. 21 illustrates a flowchart of details of the drive pulse generation process according to the fifth exemplary embodiment of the present invention.

FIG. 22 illustrates the pixel drive method and characteristics thereof according to the fifth exemplary embodiment of the present invention.

FIG. 23 illustrates the pixel drive method and characteristics thereof according to a sixth exemplary embodiment of the present invention.

FIG. 24 illustrates the pixel drive method and characteristics thereof according to a seventh exemplary embodiment of the present invention.

FIG. 25 illustrates the pixel drive method and characteristics thereof according to an eighth exemplary embodiment of the present invention.

### DESCRIPTION OF THE EMBODIMENTS

Various exemplary embodiments, features, and aspects of the invention will be described in detail below with reference to the drawings.

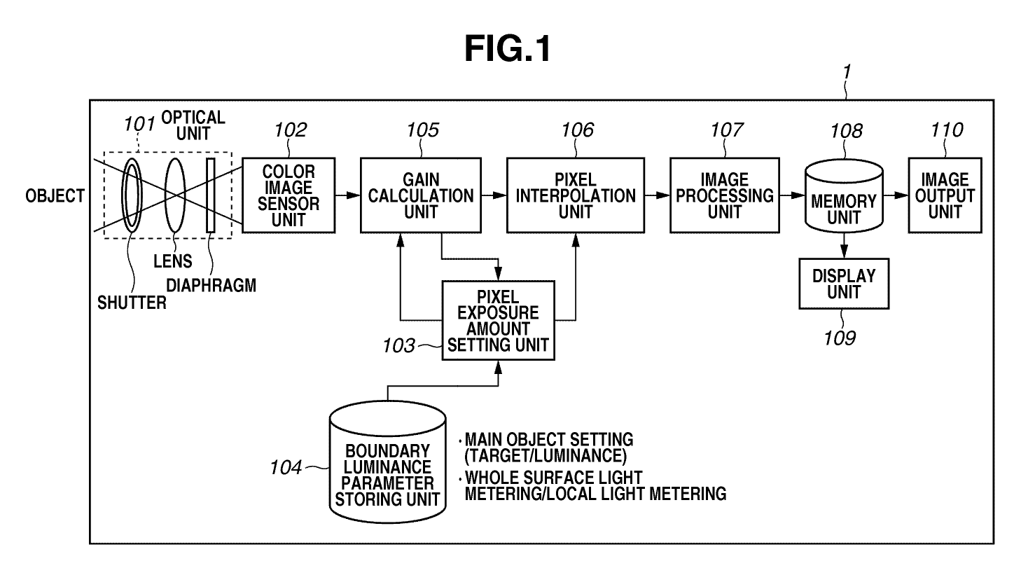

FIG. 1 illustrates a block diagram of a configuration of an image capturing apparatus according to the first exemplary embodiment of the present invention.

Referring to FIG. 1, an image capturing apparatus 1 according to the present exemplary embodiment includes an optical unit 101, a color image sensor unit 102, a pixel exposure amount setting unit 103, a boundary luminance parameter storing unit 104, a gain calculation unit 105, a pixel interpolation unit, an image processing unit 107, and a memory unit 108. Further, the image capturing apparatus 1 includes a display unit 109 and an image output unit 110.

The optical unit 101 includes a shutter, a lens, a diaphragm, and an optical low-pass filter (LPF). The color image sensor unit 102 includes color filters of a plurality of colors arranged in a mosaic form and complementary metal-oxide semiconductor (CMOS) sensors. The color image sensor unit 102 performs preliminary image capturing and main image capturing. The pixel exposure amount setting unit 103 sets the exposure amount of each pixel based on the image capturing result of the color image sensor unit 102. The boundary luminance parameter storing unit 104 stores a plurality of parameters related to the boundary luminance between exposure amounts. The gain calculation unit 105 calculates the gain of each pixel based on the image actually captured by the color image sensor unit 102 and the exposure amount set by the pixel exposure setting unit 103. The pixel interpolation unit 106 performs interpolation on the mosaic-formed image processed by the gain calculation unit 105 and acquires a plurality of independent plane images. The image processing unit 107 performs color processing, noise reduction, and sharpness improvement. The memory unit 108 records the images processed by the image processing unit 107. The display unit 109 displays the images being captured, the captured images, and the images that have been processed. An example of the display unit 109 is a liquid crystal display (LCD). The image output unit 110, such as an output I/F, can be connected to a printer, a display, and a recording medium, such as a memory card, via a cable. The images stored in the memory unit 108 are thus output to external devices via the image output unit 110.

In the present exemplary embodiment, the pixel exposure amount setting unit 103 sets the boundary luminance using a preliminary image capturing parameter stored in the boundary luminance parameter storing unit 104. The color image sensor unit 102 then captures the image based on the boundary luminance.

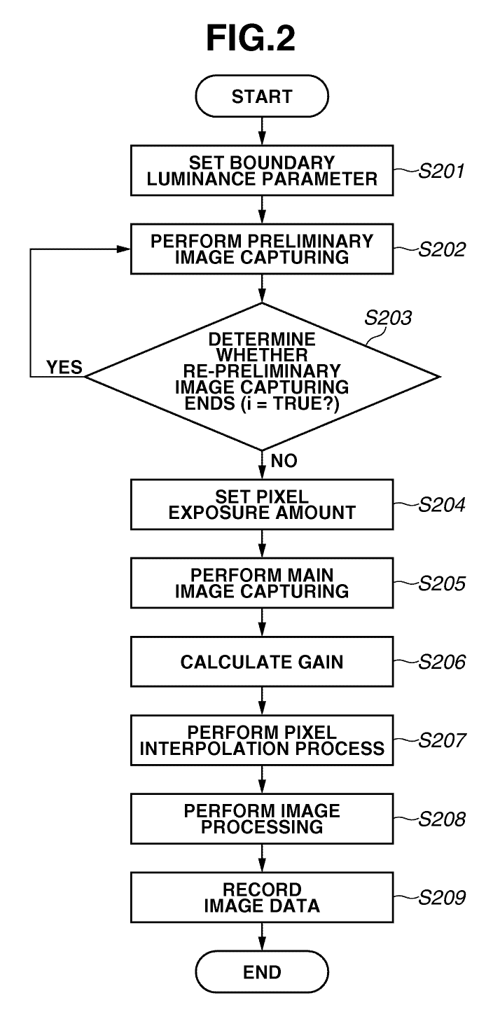

The process of capturing a wide dynamic range image performed by the image capturing apparatus 1 will be described below with reference to FIG. 2. FIG. 2 illustrates a flowchart of the operation performed by the image capturing unit 1.

In step S201, the image capturing unit 1 performs an initialization process. The display unit 109 then displays the boundary luminance parameter setting UI to which the user inputs a parameter setting. As a result, the boundary luminance parameter is stored in the boundary luminance parameter storing unit 104. In the initialization process, “FALSE” is set to a variable i, which indicates the end of the preliminary image capturing, and a memory is allocated. The boundary luminance parameter setting UI will be described in detail below.

In step S202, the color image sensor unit 102 performs preliminary image capturing via the optical unit 101.

In step S203, the pixel exposure setting unit 103 then determines whether the predetermined determination criterion is fulfilled. If it is determined that the criterion is fulfilled (YES in step S203), the variable i is set to TRUE, and the process proceeds to step S204. On the other hand, if the criterion is not fulfilled (NO in step S203), the process returns to step S202. The details of the determination will be described below.

In step S204, the pixel exposure setting unit 103 sets the exposure amount of each pixel based on a predetermined pixel exposure amount using the result of the preliminary image capturing performed in step S202. The process performed by the pixel exposure setting unit 103 will be described in detail below.

In step S205, the color image sensor unit 102 performs the main image capturing based on the exposure amount of each pixel set in step S204.

In step S206, the gain calculation unit 105 calculates the gain on the main image capturing data acquired in step S205, based on the exposure amount of each pixel set in step S204. The gain calculation will be described in detail below.

In step S207, the image interpolation unit 106 performs a pixel interpolation process on the mosaic-form captured image after the gain calculation unit 105 calculates the gain.

In step S208, the image processing unit performs image processing, such as color processing, noise reduction, and sharpness improvement.

In step S209, the memory unit 108 records the image data processed in step S207 and performs the operation of ending the process.

It is desirable that shutter speed in the initial image capturing condition of the preliminary image capturing is set sufficiently short as compared to that of the main image capturing.

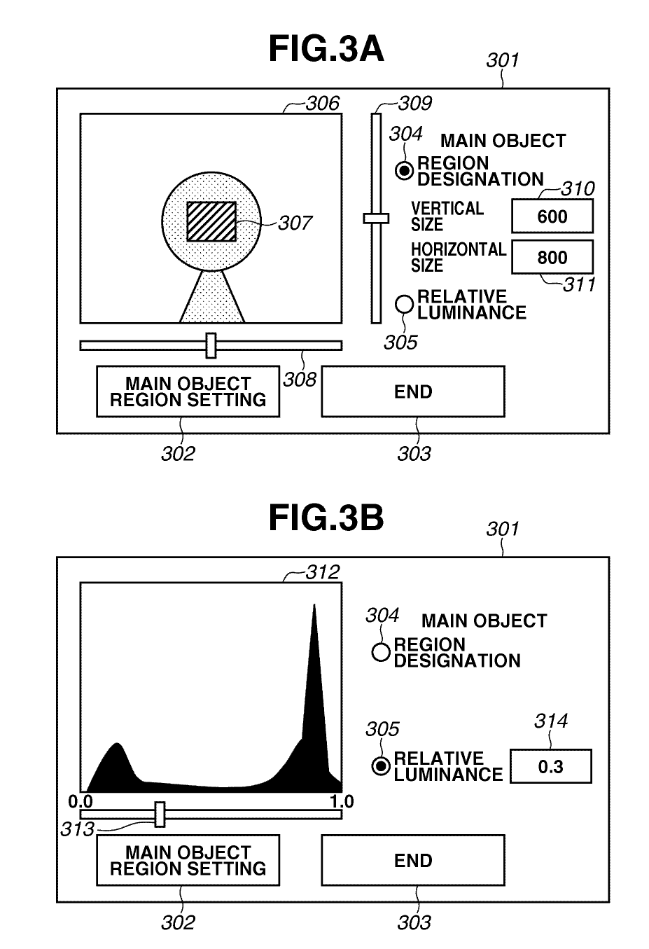

The boundary luminance parameter setting UI will be described below with reference to FIGS. 3A and 3B, which illustrate examples of the dialog window of the boundary luminance parameter setting user interface (UI) displayed in step S201 of the flowchart illustrated in FIG. 2.

Referring to FIGS. 3A and 3B, a dialog window 301 of the boundary luminance parameter setting UI displays a boundary luminance parameter setting button 302, an end button 303, a main object region designation radio button 304, and a relative luminance designation radio button 305.

When the user presses the boundary luminance parameter setting button 302 (i.e., a main object region setting button), the boundary luminance parameter storing unit 104 records the set boundary luminance parameter. If the boundary luminance parameter is set, a memory such as a random access memory (RAM) is directly released when the user pressing the end button 303. The display unit 109 then stops displaying the dialog window 301 of the boundary luminance parameter setting UI. On the other hand, if the boundary luminance parameter is not set, the boundary luminance parameter storing unit 104 records as the boundary luminance parameter an average luminance within a photometer window which is previously provided. The memory such as the RAM is then released, and the display unit 109 stops displaying the dialog window 301 of the boundary luminance parameter setting UI.

If the user selects the main object region designation radio button 304, windows 306 and 307, slide bars 308 and 309, and text boxes 310 and 311 are displayed as illustrated in FIG. 3A. On the other hand, if the user selects the relative luminance designation radio button 305, a window 312, a slide bar 313, and a text box 314 are displayed as illustrated in FIG. 3B.

The window 306 functions as a finder image display window and displays the finder image. The window 307 functions as a main object window and displays a position of the main object within the window 306 based on the setting of the slide bars 308 and 309. The slide bars 308 and 309 function as window position setting slide bars, and when the user slides the slide bars 308 and 309, the position of the window 307 is changed accordingly. The text boxes 3101 and 311 function as text boxes for designating the main object window size, and when the user inputs numerical values to the text boxes 3101 and 311, the size of the window 307 is changed accordingly.

The window 312 functions as a histogram display window and displays the histogram. The slide bar 313 functions as a main object luminance setting slide bar, and when the user slides the slide bar 313, the relative luminance to which the slide bar 313 is slid is reflected in the text box 314. In contrast, if a numerical value is input in the text box 314, the result is reflected in the slide bar 313.

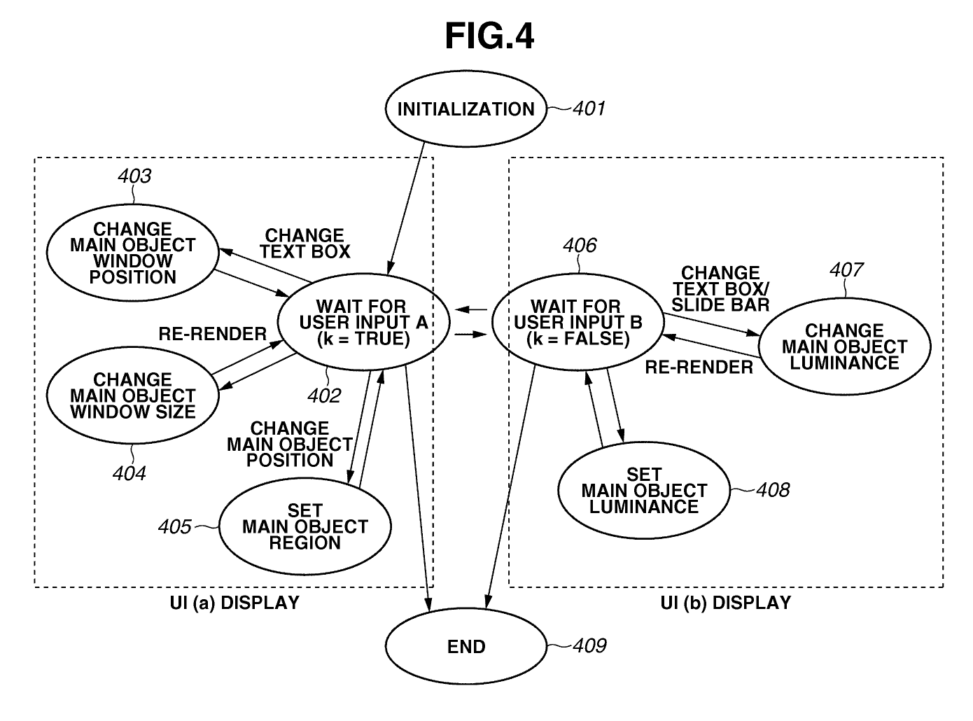

The operation for setting the boundary luminance parameter using the boundary luminance parameter setting UI will be described below with reference to FIG. 4. FIG. 4 illustrates the state transition in performing the boundary luminance parameter setting operation.

In state 401, an initial setting value is read in, and the initialization process such as displaying the boundary luminance parameter setting UI illustrated in FIG. 3A is performed. The state then shifts to state 402.

The state 402 is a waiting state for determining a user operation of the boundary luminance parameter setting UI. Further, a variable k indicating a designation pattern of the boundary luminance parameter is set to TRUE. If the user changes the position of the slide bar 308 or 309, the state shifts to state 403. In state 403, the position of the window 307 is changed, and after the window 307 is re-rendered, the state shifts to state 402. Further, if the user inputs a numerical value in the text box 310 or 311, the state shifts to state 404. In state 404, the size of the window 307 is change based on the input numerical value, and after the window 307 is re-rendered, the state shifts to state 402. When the user presses the boundary luminance parameter setting button 302, the position and the size of the window 307 and the variable k indicating the designation pattern of the boundary luminance parameter are stored in the memory unit 108. The user then presses the end button 303, and the state shifts to state 409 in which the end operation is performed.

If the user selects the relative luminance designation radio button 305 in state 402, the state shifts to state 406 and becomes a waiting state for determining the user operation of the boundary luminance parameter setting UI illustrated in FIG. 3B. Further, the variable k indicating the designation pattern of the boundary luminance parameter is set to FALSE. If the user then changes the slide bar 313 or inputs a value in the text box 314, the state shifts to state 407. In state 407, the main object luminance is changed based on the changed position of the slide bar 313 or the changed information input in the text box 314. The state then shifts to state 406. When the user presses the boundary luminance parameter setting button 302, the main object luminance and the variable k indicating the designation pattern of the boundary luminance parameter are stored in the memory unit 108. The user presses the end button 303, the state shifts to state 409 in which the end operation is performed.

The boundary luminance parameter setting UI displays the above-described window and buttons, so that the above-described operations are performed via the boundary luminance parameter setting UI.

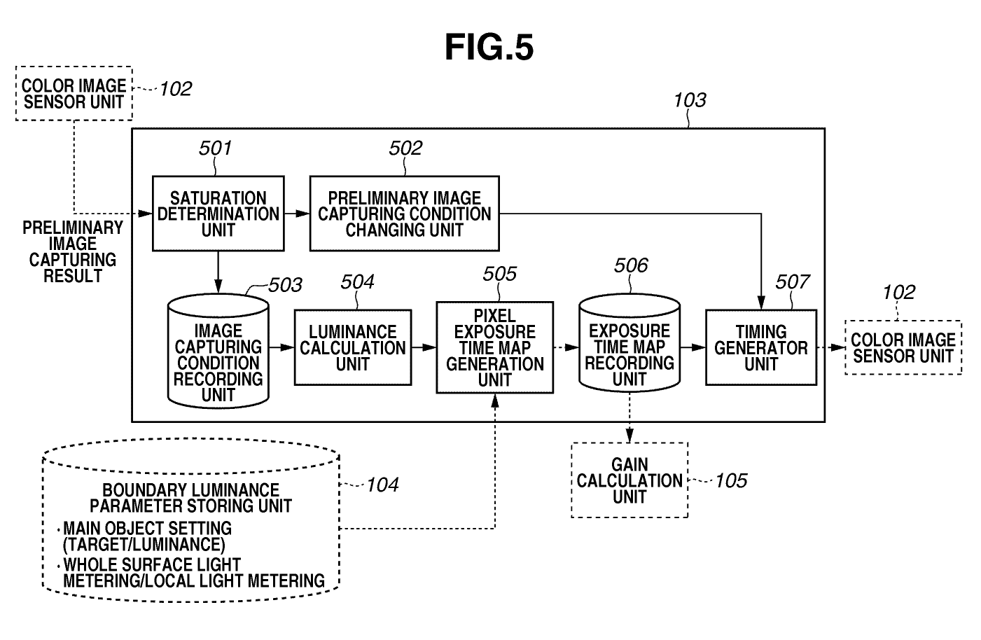

The pixel exposure amount setting unit 103 will be described below with reference to FIG. 5. FIG. 5 illustrates a block diagram of an example of the pixel exposure amount setting unit 103.

The pixel exposure amount setting unit 103 includes a saturation determination unit 501, a preliminary image capturing condition changing unit 502, an image capturing condition recording unit 503, a luminance calculation unit 504, an exposure time map generation unit 505, an exposure time map recording unit 506, and a timing generator unit 507.

The saturation determination unit 501 determines whether a saturated pixel is included in the preliminary image capturing result. The preliminary image capturing condition changing unit 502 changes the preliminary image capturing condition based on the saturation determination result. The image capturing condition recording unit 503 records the image capturing condition for each pixel to become unsaturated. The luminance calculation unit 504 calculates the luminance of each pixel based on the image capturing condition recorded in the image capturing condition recording unit 503. The exposure time map generation unit 505 generates a pixel exposure time map (exposure amount map) based on the preliminary image capturing parameter stored in the boundary luminance parameter storing unit 104 and the luminance information calculated by the luminance calculation unit 504. The exposure time map recording unit 506 records the map information generated by the exposure time map generation unit 505. The timing generator unit 507 generates a drive pulse (pixel drive signal) for a transistor in the CMOS sensor of each pixel based on the exposure time map. The information recorded in the exposure time map recording unit 506 is used in the gain calculation to be described below.

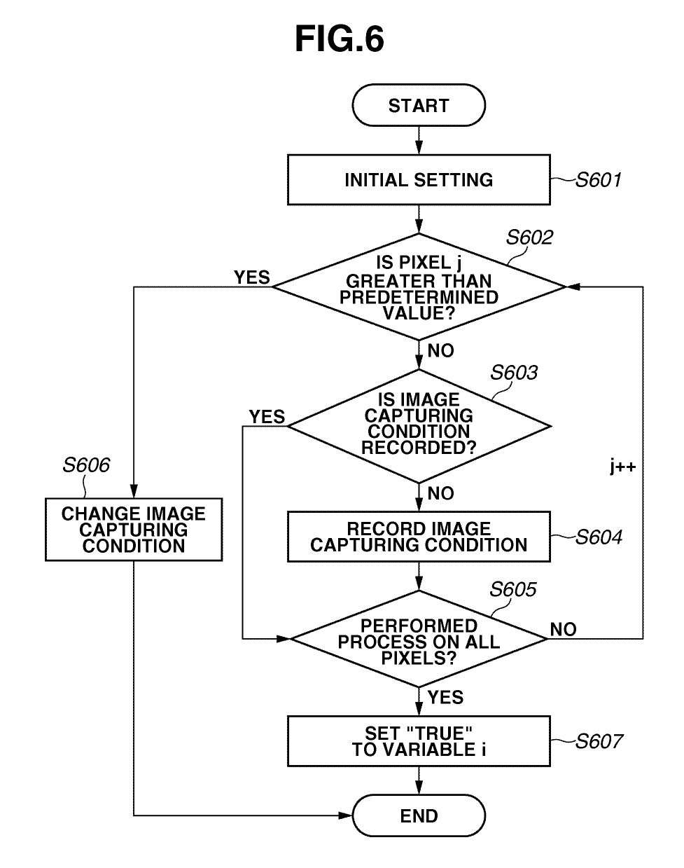

The determination process performed in step S203 (i.e., re-preliminary image capturing determination operation) will be described below with reference to FIG. 6. FIG. 6 illustrates a flowchart of the details of the re-preliminary image capturing determination operation.

In step S601, the pixel exposure amount setting unit 103 performs the initialization process. For example, the pixel exposure amount setting unit 103 sets 0 to a variable j indicating a pixel number and allocates a memory.

In step S602, the saturation determination unit 501 compares the pixel j with a predetermined value. If the pixel j is smaller than the predetermined value (NO in step S602), the process proceeds to step S603. On the other hand, if the pixel j is greater than the predetermined value (YES in step S602), the process proceeds to step S606. The predetermined value is, for example, a maximum sensor value of the color image sensor in the color image sensor unit 102 in which linearity can be maintained with respect to the luminance. The maximum value can be used as the predetermined value if the value can be acquired by the sensor.

In step S603, the pixel exposure amount setting unit 103 determines whether the image capturing condition of the pixel j is recorded in the image capturing condition recording unit 503. If it is determined that the image capturing condition is not recorded in the image capturing condition recording unit 503 (NO in step S603), the process proceeds to step S604. If it is determined that the image capturing condition is recorded (YES in step S603), the process proceeds to step S605. Examples of the image capturing condition are aperture value, shutter speed, International Organization for Standardization (ISO) sensitivity, and pixel value.

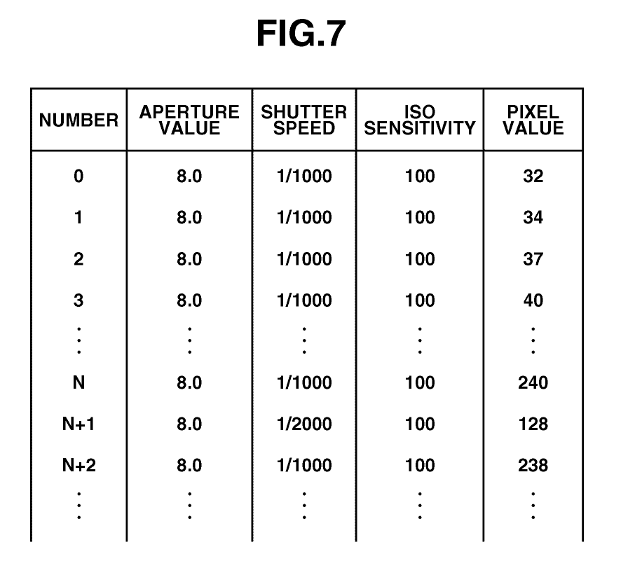

In step S604, the image capturing condition recording unit 503 records the pixel number and the image capturing condition associated with the pixel number as illustrated in FIG. 7.

In step S605, the pixel exposure amount setting unit 103 determines whether the process has been performed for all pixels. If the process has been performed for all pixels (YES in step S605), the process proceeds to step S607. If the process has not yet been performed for all pixels (NO in step S605), the variable j indicating the pixel number is incremented by 1, and the process proceeds to step S602.

In step S606, the preliminary image capturing condition changing unit 502 changes the shutter speed of the image capturing condition. Further, the timing generator unit 507 generates for all pixels a pixel drive pulse to the color image sensor unit 102, which corresponds to the same image capturing condition. The end operation is then performed.

In step S607, TRUE is set to the variable i indicating the end of the preliminary image capturing, and the end operation is performed.

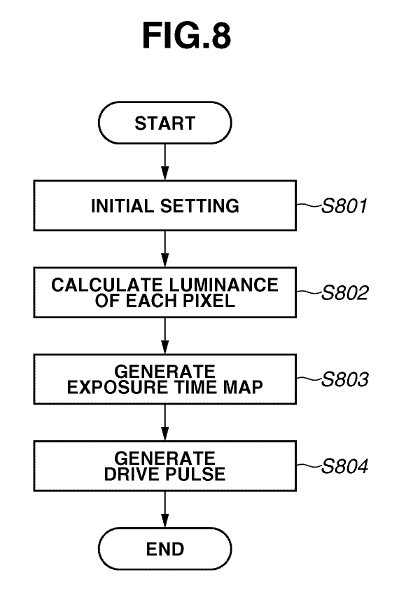

The pixel exposure amount setting operation performed in step S204 illustrated in the flowchart of FIG. 2 will be described below with reference to FIG. 8. FIG. 8 illustrates a flowchart of the details of the pixel exposure amount setting operation.

In step S801, the pixel exposure amount setting unit 103 performs the initialization process. For example, the pixel exposure amount setting unit 103 reads the aperture value, ISO sensitivity, and luminance value of each pixel stored in the image capturing condition recording unit 503 and allocates a memory.

In step S802, the luminance calculation unit 504 acquires the image capturing conditions as illustrated in FIG. 7 and calculates the luminance using equations (1) to (6) described below. In the equations, j is a variable indicating the pixel number, P is a variable indicating a pixel value, PBⱼ is a variable indicating a luminance value of the pixel, Fⱼ is a variable indicating the aperture value, Tⱼ is a variable indicating the shutter speed, ISOⱼ indicates the ISO sensitivity, and B is a variable indicating an appropriate luminance of the object. Further, AVⱼ is an APEX value indicating the aperture value, TVⱼ is an APEX value indicating the shutter speed, SVⱼ is an APEX value indicating the ISO sensitivity, and BVⱼ is an APEX value indicating the object luminance.

More specifically, the luminance calculation unit 504 calculates each APEX value of the pixel number j based on the image capturing condition using equations (1), (2), and (3).

AVⱼ=2 log₂(Fⱼ) (1)

TVⱼ=−log₂(Tⱼ) (2)

SVⱼ=log₂(ISOⱼ/3.125) (3)

The luminance calculation unit 504 then calculates the APEX value of the object luminance using equation (4).

BVⱼ=AVⱼ+TVⱼ−SVⱼ (4)

The luminance calculation unit 504 then calculates the object luminance using equation (5).

Bⱼ=2^{BVj}×N÷K (wherein N and K are constants) (5)

The luminance calculation unit 504 then calculates the luminance of the pixel number i using equation (6).

PBⱼ=Bⱼ×(Pⱼ÷maximum signal value)×(100÷18) (6)

In step S803, the pixel exposure time map generation unit 505 generates the exposure time map, which is then recorded by the exposure time map recording unit 506. The exposure time map will be described in detail below.

In step S804, the timing generator unit 507 generates the drive pulses for the pixels based on the exposure time map generated in step S803. The process then ends.

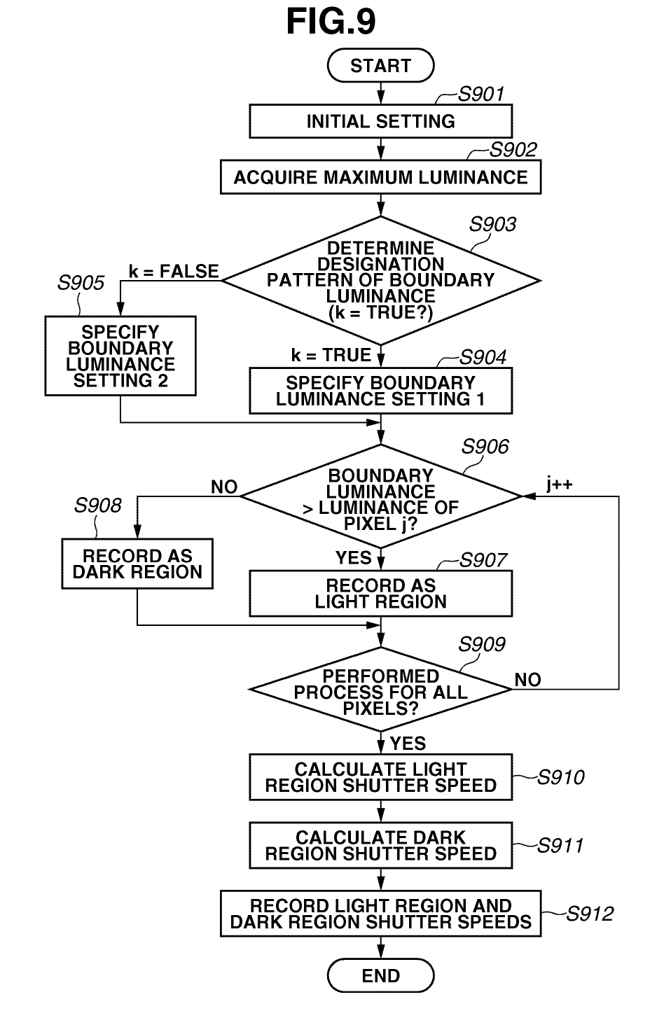

The exposure time map generation process performed in step S803 will be described below with reference to FIG. 9. FIG. 9 illustrates a flowchart of the details of the exposure time map generation process.

In step S901, the pixel exposure amount setting unit 103 performs the initialization process. For example, the pixel exposure amount setting unit 103 reads the boundary luminance parameter stored in the boundary luminance parameter storing unit 104. The pixel exposure amount setting unit 103 also reads the aperture value, ISO sensitivity, and luminance value of each pixel stored in the image capturing condition recording unit 503, and allocates a memory.

In step S902, the pixel exposure time map generation unit 505 scans the luminance values of all pixels and acquires the maximum luminance value MB.

In step S903, the pixel exposure time map generation unit 505 determines whether the variable k indicating the designation pattern of the boundary luminance parameter is TRUE. If the variable k is TRUE (YES in step S903), the process proceeds to step S904. On the other hand, if the variable k is not TRUE (NO in step S903), the process proceeds to step S905.

In step S904, the pixel exposure time map generation unit 505 calculates the boundary luminance parameter using equations (7) and (8) based on the luminance information on the designated region position of the boundary luminance parameter and the maximum luminance value MB acquired in step S902. Further, the pixel exposure time map generation unit 505 sets the boundary luminance. Hereinafter, a region in which the luminance is less than the boundary luminance will be referred to as a light region, and a region in which the luminance is greater than or equal to the boundary luminance will be referred to as a dark region. In the equations, the size of the designated region is indicated as m×n. Further, PBₖ indicates luminance of each pixel, PBₐᵥₑ indicates average luminance, and SB indicates boundary luminance.

$$\begin{matrix}{PB}_{ave} = {\sum }_{1}^{m \times n} \frac{{PB}_{k}}{m \times n} & ( 7 ) \\ SB = {PB}_{ave} \times ( 100 \div 18 ) & ( 8 )\end{matrix}$$

In step S905, the pixel exposure time map generation unit 505 calculates the boundary luminance using equation (9) based on the maximum luminance value MB acquired in step S902 and the boundary luminance parameter. Further, the pixel exposure time map generation unit 505 sets the boundary luminance SB.

SB=boundary luminance parameter×MB (9)

In step S906, the pixel exposure time map generation unit 505 compares the luminance value of the pixel number j with the set boundary luminance. If the luminance value of the pixel number j is less than the set boundary luminance (YES in step S906), the process proceeds to step S907. On the other hand, if the luminance value of the pixel number j is greater than or equal to the set boundary luminance (NO in step S906), the process proceeds to step S908.

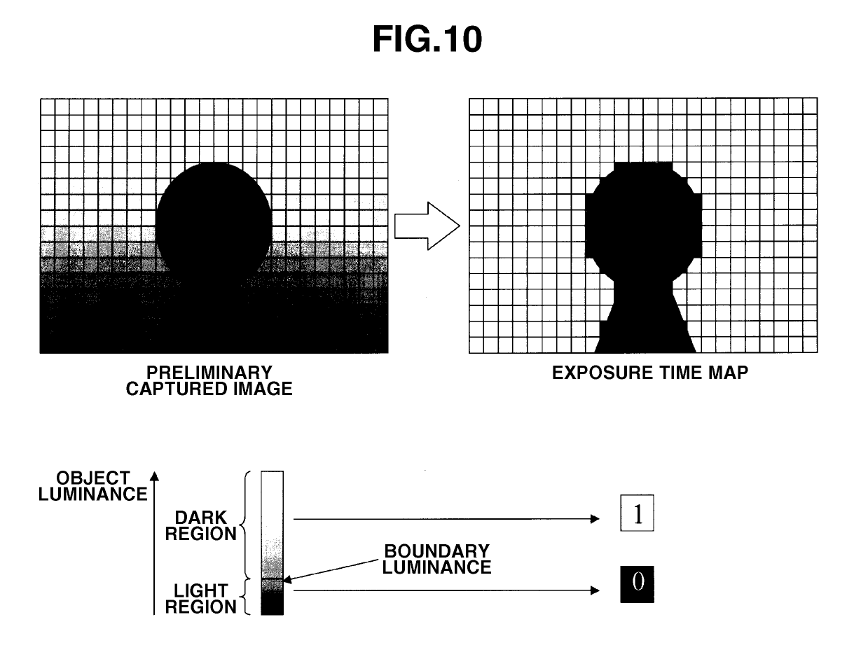

In step S907, the pixel exposure time map generation unit 505 records 0, which indicates the light region. In step S908, the pixel exposure time map generation unit 505 records 1, which indicates the dark region. For example, the pixel exposure time map is recorded as illustrated in FIG. 10.

In step S909, the pixel exposure time map generation unit 505 determines whether the process has been performed for all pixels. If the process has been performed for all pixels (YES in step S909), the process proceeds to step S910. If the process has not yet been performed for all pixels (NO in step S909), the variable j indicating the pixel number is incremented by 1. The process then returns to step S906.

In step S910, the pixel exposure time map generation unit 505 calculates, using equations (10), (11), and (12), a shutter speed T_{light} for the light region.

More specifically, the pixel exposure time map generation unit 505 calculates BV_{light} of the main object using equation (10).

BV_{light}=log₂(SB×N÷K) (10)

The pixel exposure time map generation unit 505 then calculates AV_{light} and SV_{light} using equations (1) and (3) and calculates TV_{light} using equation (11).

TV_{light}=SV_{light}+BV_{light}−AV_{light} (11)

The pixel exposure time map generation unit 505 then calculates the shutter speed T_{light} of the light region using equation (12).

T_{light}=2^{-Tlight} (12)

In step S911, the pixel exposure time map generation unit 505 uses equations (13), (14), and (15) and calculates a shutter speed T_{dark} for the dark region.

More specifically, the pixel exposure time map generation unit 505 calculates BV_{dark} of the main object using equation (13).

BV_{dark}=log₂(MB×N÷K) (13)

The pixel exposure time map generation unit 505 then calculates AV_{light} and SV_{light} using equations (1) and (3) and calculates TV_{dark} using equation (14).

TV_{dark}=SV_{dark}+BV_{dark}−AV_{dark} (14)

The pixel exposure time map generation unit 505 then calculates the shutter speed T_{dark} for the dark region using equation (15).

T_{dark}=2^{-TVdark} (15)

In step S912, the exposure time map recording unit 506 stores T dark indicating the shutter speed for the dark region and T_{light} indicating the shutter speed for the light region. The process then ends.

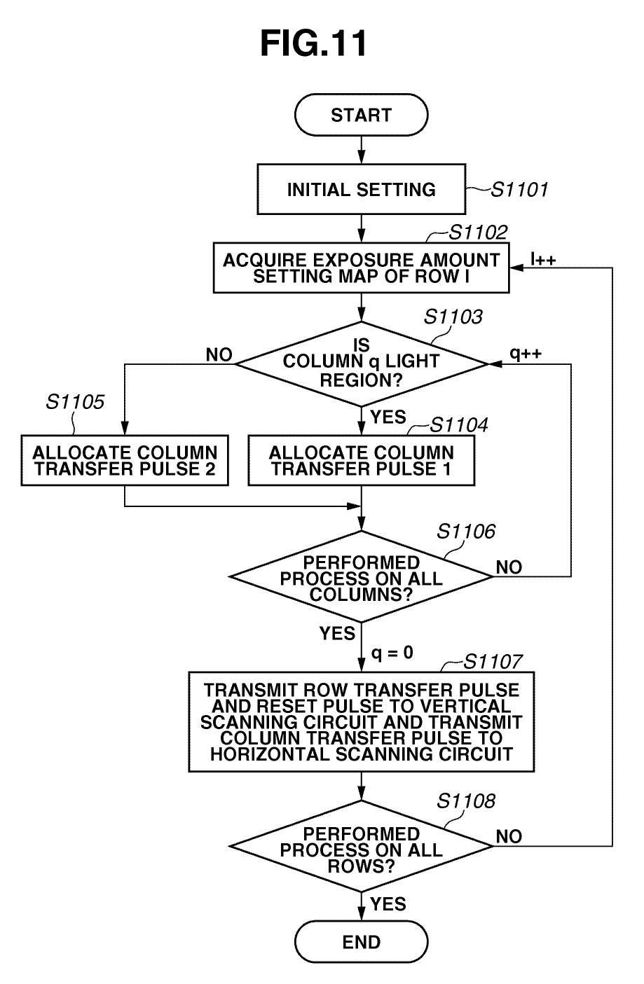

The drive pulse generation process performed in step S804 illustrated in FIG. 8 will be described below with reference to FIG. 11. FIG. 11 illustrates a flowchart of the details of the drive pulse generation process according to the first exemplary embodiment.

In step S1101, the timing generator unit 507 performs the initialization process. For example, the timing generator unit 507 sets 0 to both a variable 1, which indicates a row and a variable q, which indicates a column.

In step S1102, the timing generator unit 507 reads all values of the exposure amount setting map in the first row.

In step S1103, the timing generator unit 507 determines whether the shutter speed of the pixel in the q-th column is the shutter speed of the pixel in the light region. If the shutter speed of the pixel in the q-th column is the shutter speed of the pixel in the light region (YES in step S1103), the process proceeds to step S1104. On the other hand, if the shutter speed of the pixel in the q-th column is not the shutter speed of the pixel in the light region (NO in step S1103), the process proceeds to step S1105.

In step S1104, the timing generator unit 507 assigns to the pixel in the q-th column of the first row the drive pulse to a column transfer transistor that corresponds to the shutter speed of the light region. In step S1105, the timing generator unit 507 assigns to the pixel in the q-th column of the first row the drive pulse to the column transfer transistor that corresponds to the shutter speed of the dark region.

In step S1106, the timing generator unit 507 determines whether the drive pulse has been assigned to the pixels in all columns of the row. If the drive pulse has been assigned to the pixels in all columns of the row (YES in step S1106), the timing generator unit 507 sets 0 to the variable q indicating the column. The process then proceeds to step S1107. If the drive pulse has not been assigned to the pixels in all columns of the row (NO in step S1106), the timing generator unit 507 adds 1 to the variable q. The process then returns to step S1103.

In step S1107, the timing generator unit 507 generates the drive pulses to a row transfer transistor and a reset transistor (i.e., a first row transfer pulse, a second row transfer pulse, and a reset pulse) with respect to the pixels in the first row. Further, the timing generator unit 507 transmits the generated drive pulses to a vertical scan circuit. Furthermore, the timing generator unit 507 generate the drive pulse of the column transfer transistor (i.e., a column transfer pulse) assigned in step S1104 or step S1105, and transmits the drive pulse to a horizontal scan circuit.

In step S1108, the timing generator unit 507 determines whether the drive pulses have been transmitted to all rows. If the drive pulses have been transmitted to all rows (YES in step S1108), the process ends. If the drive pulses have not been transmitted to all rows (NO in step S1108), the variable 1 indicating the row is incremented by 1. The process then returns to step S1102.

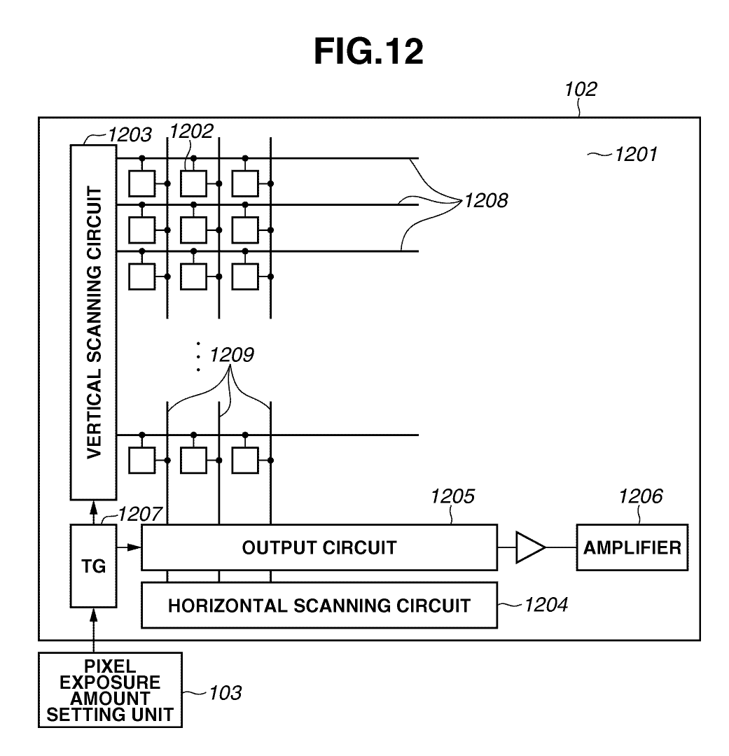

The color image sensor unit 102 will be described below with reference to FIG. 12. FIG. 12 illustrates an example of the arrangement of the elements configuring the color image sensor unit 102.

Referring to FIG. 12, a plurality of pixels 1202 are aligned in the horizontal direction and the vertical direction (two-dimensional) on an imaging plane 1201 of the color image sensor unit 102. Further, a vertical scan circuit 1203, a horizontal scan circuit 1204, an output circuit 1205, an output amplifier 1206, and a timing generator 1207 are disposed on the imaging plane 1201 of the color image sensor unit 102. Furthermore, a row selection line 1208 connects the pixels 1202 which are horizontally aligned in each row and the vertical scan circuit unit 1203. A column signal line 1209 connects the pixels 1202 which are vertically aligned in each column, the horizontal scan circuit 1204, and the output circuit 1205. Control is thus performed for each predetermined unit of the row or the column (i.e., for each predetermined row or for each predetermined column).

In performing image capturing using the color image sensor unit 102, the timing generator 1207 outputs to the vertical scan circuit 1203 and the output circuit 1205 the drive pulses generated by the timing generator unit 507 based on the exposure amount settings by the pixel amount setting unit 103. Reset and read out control in each pixel 1202 are thus performed by the drive pulse turning on and off the transistor. The read out charge is then converted to a voltage and sequentially transferred from the horizontal scan circuit 1204 to the output circuit 1205 and output to the output amplifier 1206.

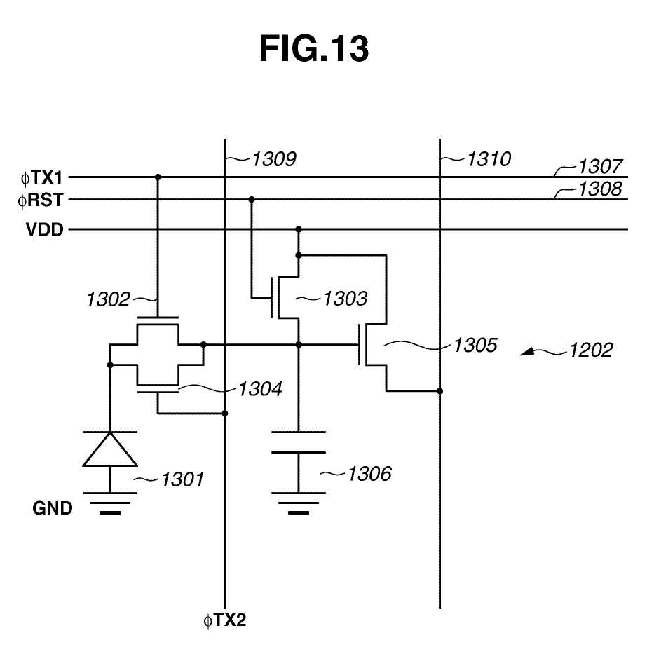

FIG. 13 illustrates a circuit diagram of an example of a structure of the pixel 1202 according to the first exemplary embodiment.

The pixel 1202 includes an embedded photodiode (PD) 1301, which is a light-sensitive element, and N-channel metal-oxide semiconductor (MOS) transistors 1302, 1303, 1304, and 1305. A floating diffusion (FD) 1306 is connected to drains of the transistor 1302 and the transistor 1304 and a source of the transistor 1303. A row selection line 1307, a row signal line 1308, a column selection line 1309, and a column signal line 1310 transmit a signal to each transistor. Further, VDD indicates a power source, and GND indicates grounding. The transistor is turned on and becomes conductive when a high-level (H) signal is supplied to the gate thereof, and is turned off and becomes non-conductive when a low-level (L) signal is supplied to the gate.

A photoelectric conversion unit (PD) 1301 (light receiving unit) temporarily accumulates the charge corresponding to the amount of light input from the object. The accumulated signal charge is output by the row transfer transistor 1302 or the column transfer transistor 1304, i.e., transfer gate, completely transferring the accumulated signal charge to the FD 1306. The transferred signal charge is then temporarily accumulated in the FD 1306, which functions as an accumulation unit. Hereinafter, a potential of the row transfer transistor 1302 will be indicated as φTX1, and a potential of the column transfer transistor 1304 will be indicated as φTX2.

The transistor 1303 is referred to as a reset transistor, and the FD 1306 is reset to a predetermined potential (φRSB) when the transistor 1303 is turned on and becomes conductive. Such reset operation may generate reset noise by which the potential of the FD 1306 fluctuates with respect to the predetermined potential φRSB each time the reset operation is performed.

The transistor 1305 is part of a source follower amplifier circuit. The transistor 1305 amplifies the current with respect to a potential VFD of the FD 1306 and lowers the output impedance. Further, the drain of the transistor 1305 is connected to the column signal line 1310, so that the impedance is lowered, and the signal is transferred as a pixel output VOUT to the column signal line 1310.

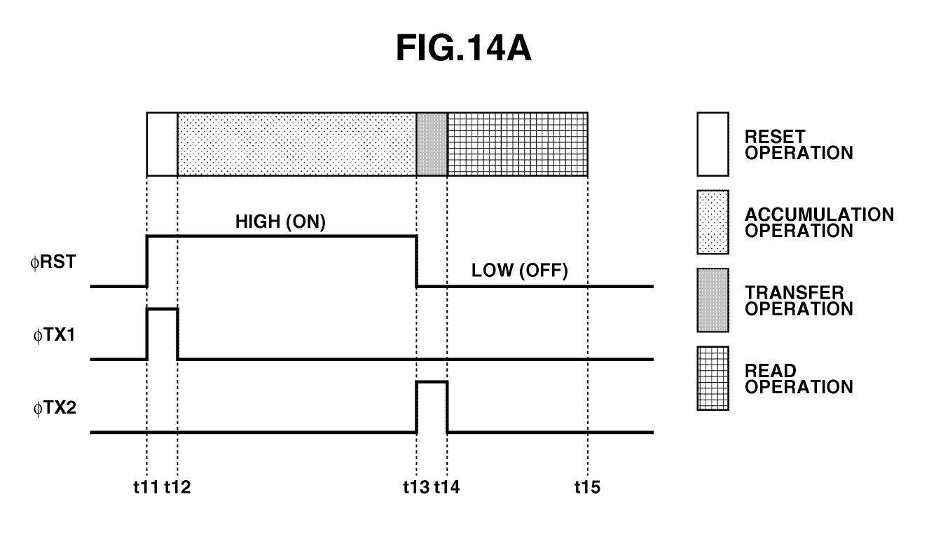

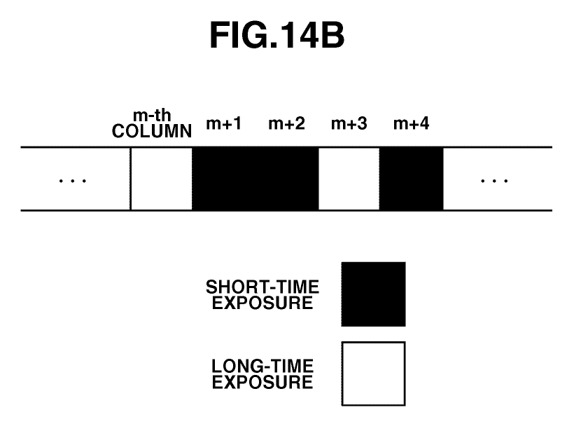

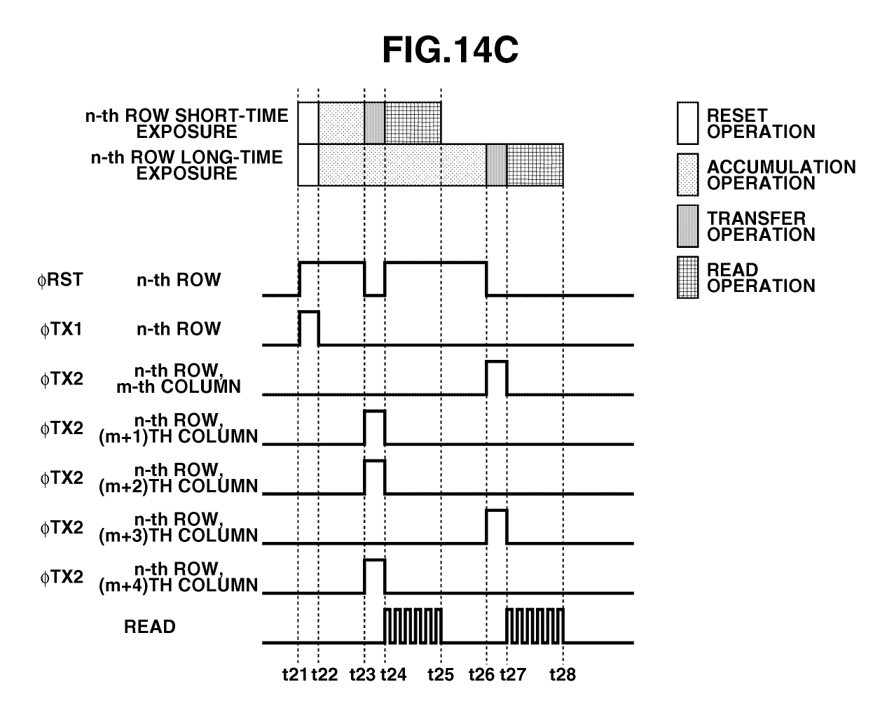

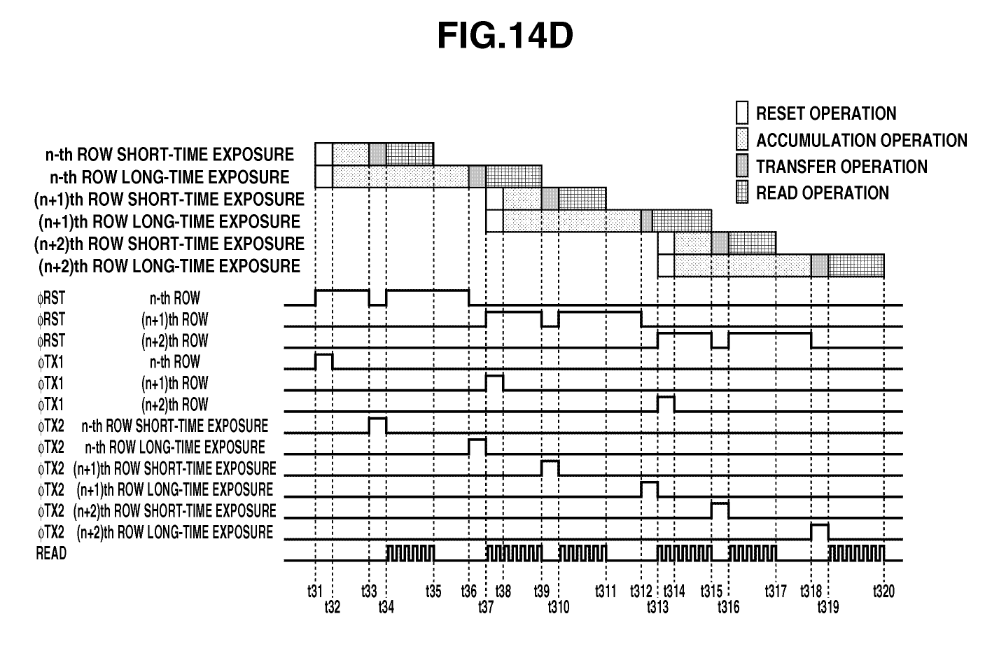

FIGS. 14A, 14B, 14C, and 14D illustrate drive methods for the pixel 1202 illustrated in FIG. 13 and their characteristics. FIG. 14A illustrates a timing chart of the drive method for controlling the transistor 1302 and transistor 1304, i.e., transfer gates, and the reset transistor 1303 to be turned on and becoming conductive/turned off and becoming non-conductive.

Referring to FIG. 14A, at timing t11, the reset transistor 1303 and the row transfer transistor 1302 are turned on. As a result, the charge of the PD 1301 is completely transferred to the FD 1306, so that the PD 1301 is reset, and the FD 1306 is reset to the drain potential of the reset transistor 1303 (i.e., a first reset and a second reset). At timing t12 after a predetermined time period from the timing t11, the row transfer transistor 1302 is turned off. The PD 1301 thus starts accumulating the charge. Further, the reset transistor 1303 remains turned on, and the noise generated in the FD 1306 during exposure is removed before the column transfer transistor 1304 is turned on. Hereinafter, description on the state of the transistor in which there is no change in the operation will be omitted. At timing t13 after a predetermined time from the timing t11, the reset transistor 1303 is turned off and the column transfer transistor 1304 is turned on. The charge of the PD 1301, which accumulates the light from the object, is then completely transferred to the FD 1306 (i.e., a first transfer and a second transfer). At timing t14 after a predetermined time period from the timing t11, the transistor 1305 is turned on. As a result, the impedance in the potential of the FD 1306 is lowered, and the potential is transferred as the pixel output VOUT to the signal line connected to the output circuit 1205. At timing t15 after a predetermined time period from the timing t11, the potential is stopped from being transferred to the signal line connected to the output circuit 1205 (i.e., a third transfer).

A method of controlling long-time exposure and short-time exposure by transmitting two types of column transfer pulses to each pixel in the line will be described below with reference to FIGS. 14B and 14C. The long-time exposure and the short-time exposure in the present exemplary embodiment can be controlled by applying either of the two types of column transfer pulses as the turn-on timing to each column transfer transistor. FIG. 14B illustrates a schematic diagram of the exposure amounts of the m-th column to the (m+4)th column in the n-th row of the image-captured pixels. The white portion indicates the long-time exposure, and the black portion indicates the short-time exposure. Further, FIG. 14C illustrates a timing chart of the drive method for controlling the row transfer transistor 1302, the column transfer transistor 1304, and the reset transistor 1303 to be turned on and becoming conductive/turned off and becoming non-conductive. Furthermore, t21, t22, t23, t24, t25, t26, t27, and t28 indicate timing.

Referring to FIG. 14C, at timing t21, all reset transistors 1303 and all row transfer transistors 1302 are turned on. As a result, the charges of all PDs 1301 are completely transferred to the FDs 1306, so that the PDs 1301 are reset, and all FDs 1306 are reset to the drain potential of the reset transistor 1303.

At timing t22, all row transfer transistors 1302 are turned off. All PDs 1301 thus start accumulating the charge.

At timing t23, the reset transistor 1303 is turned off, and the column transfer transistors 1304 in (m+1)th column, (m+2)th column, and (m+4)th column to which short-time exposure are assigned are turned on. The charges of the PDs 1301 acquired from the light received from the object are then completely transferred to the FDs 1306.

At timing t24, the column transfer transistors 1304 in (m+1)th column, (m+2)th column, and (m+4)th column to which the short-time exposure is assigned are turned off, and the transistor 1305 is turned on. As a result, the impedance is lowered in the potentials of the FDs 1306, and the potentials are individually transferred to the signal lines connected to the output circuit 1205 as short-time exposure pixel outputs VOUT_{S}. The reset transistor 1303 is then turned on and the column transfer transistor 1304 is turned off.

At timing t25, transfer of the short-time exposure pixel output VOUT_{S} to the signal line connected to the output circuit 1205 ends.

At timing t26, the reset transistor 1303 is turned off, and the column transfer transistors 1304 in m-th column and (m+3)th column to which long-time exposure are assigned are turned on. The charge of the PD 1301 acquired from the light received from the object is then completely transferred to the FD 1306.

At timing t27, the column transfer transistors 1304 in the m-th column and the (m+3)th column to which the long-time exposure is assigned are turned off, and the transistor 1305 is turned on. As a result, the impedance is lowered in the potential of the FD 1306, and the potentials are individually transferred to the signal lines connected to the output circuit 1205 as long-time exposure pixel outputs VOUT_{L}.

At timing t28, transfer of the long-time exposure pixel output VOUT_{L} to the signal line connected to the output circuit 1205 ends.

A method of controlling the long-time exposure and the short-time exposure by transmitting two types of column transfer pulses to each pixel in the line will be described below with reference to FIG. 14D. FIG. 14D illustrates a timing chart of the driving method for controlling the row transfer transistor 1302, the column transfer transistor 1304, and the reset transistor 1303 to be turned on and becoming conductive/turned off and becoming non-conductive. Furthermore, t31, t32, t33, t34, t35, t36, t37, t38, t39, t310, t311, t312, t313, t314, t315, t316, t317, t318, t319, and t320 indicate timing.

Referring to FIG. 14D, at timing t31, all reset transistors 1303 and all row transfer transistors 1302 in the n-th row are turned on. As a result, the charges of all PDs 1301 in the n-th row are completely transferred to the FD 1306, so that the PDs 1301 are reset, and all FDs 1306 in the n-th row are reset to the drain potential of the reset transistor 1303.

At timing t32, all row transfer transistors 1302 in the n-th row are turned off. All PDs 1301 in the n-th row thus start accumulating the charges.

At timing t33, all reset transistors 1303 in the n-th row are turned off, and the column transfer transistor 1304 of the column to which the short-time exposure is assigned in the n-th row is turned on. The charge of the PD 1301 acquired from the light received from the object is then completely transferred to the FD 1306.

At timing t34, the column transfer transistor 1304 of the column to which the short-time exposure is assigned in the n-th row is turned off, and the transistor 1305 in the n-th row is turned on. As a result, the impedance is lowered in the potential of the FD 1306, and the potential is transferred as a short-time exposure pixel output of the n-th row VOUTₙ_{_{—}}ₛ to the signal line connected to the output circuit 1205. All reset transistors 1303 in the n-th row are then turned on.

At timing t35, transfer of the short-time exposure pixel output VOUTₙ_{_{—}}ₛ to the signal line connected to the output circuit 1205 ends.

At timing t36, all reset transistors 1303 in the n-th row are turned off, and the column transfer transistor 1304 of the column to which the long-time exposure is assigned in the n-th row is turned on. The charge of the PD 1301 acquired from the light received from the object is then completely transferred to the FD 1306.

At timing t37, the column transfer transistor 1304 of the column to which the long-time exposure is assigned in the n-th row is turned off, and the transistor 1305 in the n-th row is turned on. As a result, the impedance is lowered in the potential of the FD 1306, and the potential is transferred as a long-time exposure pixel output in the n-th row VOUTₙ_{_{—}}_{L} to the signal line connected to the output circuit 1205. Further, all reset transistors 1303 and all row transfer transistors 1302 in the (n+1)th row are turned on. The charges in all PDs 1301 in the (n+1)th row are completely transferred to the FDs 1306, and all FDs 1306 in the (n+1)th row are reset to the drain potential of the reset transistor 1303 in the (n+1)th row.

At timing t38, all row transfer transistors 1302 in the (n+1)th row are turned off, and all PDs 1301 in the (n+1)th row thus start accumulating the charges.

At timing 39, the reset transistor 1303 in the (n+1)th row is turned off, and the column transfer transistor 1304 of the column to which the short-time exposure is assigned in the (n+1)th row is turned on. The charge of the PD 1301 acquired from the light received from the object is thus completely transferred to the FD 1306. Transfer of the long-time exposure pixel output VOUTₙ_{_{—}}_{L} to the signal line connected to the output circuit 1205 then ends.

At timing t310, the column transfer transistor 1304 to which the short-time exposure is assigned in the (n+1)th row is turned off, and the transistor 1305 in the (n+1)th row is turned on. As a result, the impedance is lowered in the potential of the FD 1306, and the potential is transferred to the signal line connected to the output circuit 1205 as a short-time exposure pixel output of the (n+1)th row VOUTₙ₊₁_{_{—}}_{S}. The reset transistor 1303 is then turned on.

At timing t311, transfer of the short-time exposure pixel output VOUTₙ₊₁_{_{—}}_{S} to the signal line connected to the output circuit 1205 ends.

At timing t312, all reset transistors 1303 in the (n+1)th row are turned off, and the column transfer transistor 1304 in the column to which the long-time exposure is assigned in the (n+1)th row is turned on. The charge of the PD 1301 acquired from the light received from the object is then completely transferred to the FD 1306.

At timing t313, the column transfer transistor 1304 to which the long-time exposure is assigned in the (n+1)th row is turned off, and the transistor 1305 in the (n+1)th row is turned on. As a result, the impedance is lowered in the potential of the FD 1306, and the potential is transferred to the signal line connected to the output circuit 1205 as a long-time exposure pixel output of the (n+1)th row VOUTₙ₊₁_{_{—}}_{L}. The reset transistor 1303 is then turned on. Further, all reset transistors 1303 and all row transfer transistors 1302 in the (n+2)th row are turned on. The charges in all PDs 1301 in the (n+2)th row are thus completely transferred to the FD 1306, and all FDs 1306 in the (n+2)th row are reset to the drain potential of the reset transistor 1303.

At timing t314, all row transfer transistors 1302 in the (n+2)th row are turned off, and all PDs 1301 in the (n+2)th row thus start accumulating the charges.

At timing t315, the reset transistors 1303 in the (n+2)th row are turned off, and the column transfer transistor 1304 of the column to which the short-time exposure is assigned in the (n+2)th row is turned on. The charge of the PD 1301 acquired from the light received from the object is thus completely transferred to the FD 1306. Transfer of the long-time exposure pixel output VOUTₙ₊₁_{_{—}}_{L} to the signal line connected to the output circuit 1205 then ends.

At timing t316, the column transfer transistor 1304 of the column to which the short-time exposure is assigned in the (n+2)th row is turned off, and the transistor 1305 in the (n+2)th row is turned on. As a result, the impedance is lowered in the potential of the FD 1306, and the potential is transferred as a short-time exposure pixel output of the (n+2)th row VOUTₙ₊₂_{_{—}}_{S} to the signal line connected to the output circuit 1205. The reset transistor 1303 is then turned on.

At timing t317, transfer of the short-time exposure pixel output VOUTₙ₊₂_{_{—}}_{S} to the signal line connected to the output circuit 1205 ends.

At timing t318, the reset transistor 1303 in the (n+2)th row is turned off, and the column transfer transistor 1304 of the column to which the long-time exposure is assigned in the (n+2)th row is turned on. The charge of the PD 1301 acquired from the light received from the object is then completely transferred to the FD 1306.

At timing t319, the column transfer transistor 1304 of the column to which the long-time exposure is assigned in the (n+2)th row is turned off, and the transistor 1305 in the (n+2)th row is turned on. As a result, the impedance is lowered in the potential of the FD 1306, and the potential is transferred as a long-time exposure pixel output of the (n+2)th row VOUTₙ₊₂_{_{—}}_{L} to the signal line connected to the output circuit 1205.

At timing t320, transfer of the long-time exposure pixel output VOUTₙ₊₂_{_{—}}_{L} to the signal line connected to the output circuit 1205 ends.

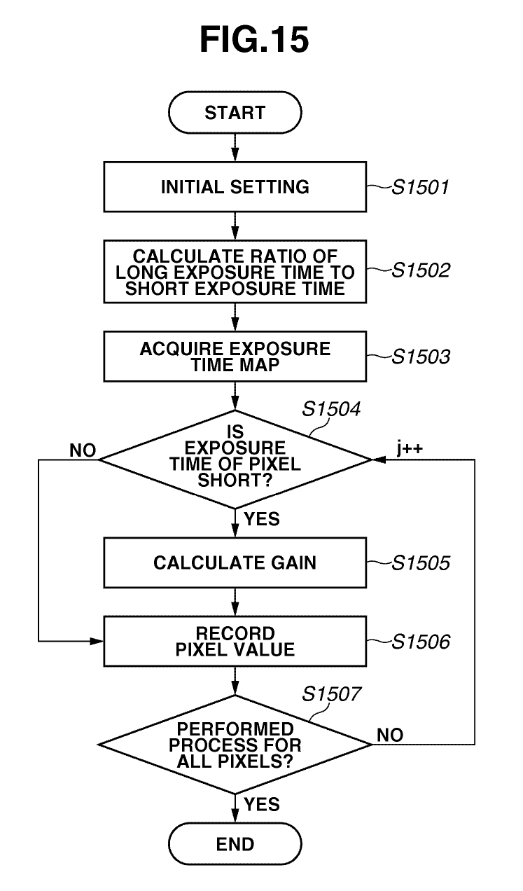

The gain calculation performed in step S206 illustrated in the flowchart of FIG. 2 will be described below with reference to FIG. 15. FIG. 15 illustrates a flowchart of the details of the gain calculation.

In step S1501, the gain calculation unit 105 performs the initialization process. For example, the gain calculation unit 105 sets 0 to the variable j indicating the pixel number, acquires the image capturing result and the lengths of the long-time exposure and the short-time exposure, and allocates a memory.

In step S1502, the gain calculation unit 105 calculates using equation (16) a ratio α of long exposure time T_{L} to short exposure time T_{S} acquired in step S1501.

α=T_{L}÷T_{S} (16)

In step S1503, the gain calculation unit 105 acquires the exposure time maps of all pixels.

In step S1504, the gain calculation unit 105 determines whether the exposure time of the pixel number j is short-time. If the exposure time of the pixel number j is short-time (YES in step S1504), the process proceeds to step S1505. On the other hand, if the exposure time of the pixel number j is not short-time (NO in step S1504), the process proceeds to step S1506.

In step S1505, the gain calculation unit 105 calculates using equation (17) the gain based on a pixel value Pⱼ of the pixel number j and the exposure time ratio α.

Pⱼ=α×Pⱼ (17)

In step S1506, the gain calculation unit 105 records the pixel value Pⱼ.

In step S1507, the gain calculation unit 105 determines whether the process has been performed for all pixels. If the process has been performed for all pixels (YES in step S1507), the process ends. If the process has not been performed for all pixels (NO in step S1507), the pixel number j is incremented by 1. The process then returns to step S1504.

As described above, according to the first exemplary embodiment, the long-time exposure and the short-time exposure can be controlled for each pixel by setting either of the two types of timing at which each column transfer transistor is turned on. As a result, a wide dynamic range can be acquired without a loss of highlight detail and a loss of shadow detail, by assigning exposure time to each pixel using the object luminance acquired in the preliminary image capturing. Further, since the exposure amount is controlled by the exposure time, the sensitivity can be freely changed, so that the object images with various dynamic ranges can be captured. Furthermore, since image capturing at a wide dynamic range can be implemented at once, the problem of position displacement when the images are combined can be solved even when moving images are captured. Moreover, as compared to performing a wide dynamic range image capturing using the fixed pattern, the present exemplary embodiment can prevent resolution reduction and noise generation in performing the short-time exposure which is inappropriate for the object luminance.

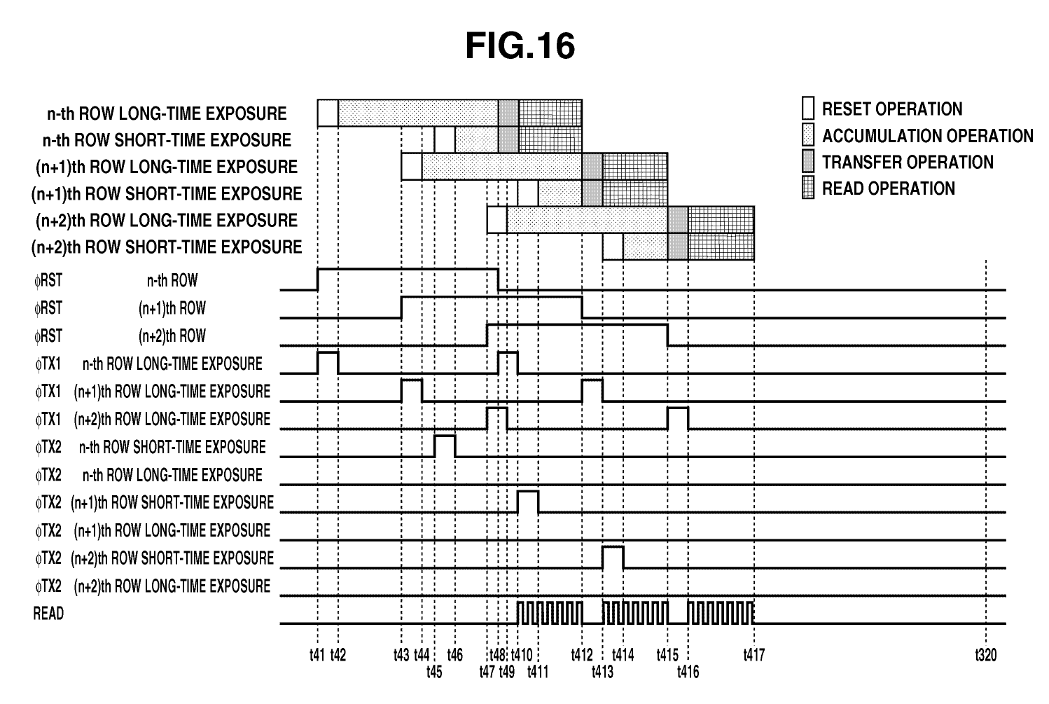

In a second exemplary embodiment of the present invention, the speed of reading out the pixel is increased when controlling the long-time exposure and the short-time exposure by transmitting two types of column transfer pulses to each pixel in each line. In the present exemplary embodiment, the long-time exposure and the short-time exposure are controlled by setting either of two types of reset timing. One of the timing is a combination of the column transfer transistor 1302 and the reset transistor 1303. The other timing is a combination of the column transfer transistor 1304 and the reset transistor 1303. FIG. 16 illustrates a driving method for the pixel 1202 and its characteristic according to the second exemplary embodiment. More specifically, FIG. 16 is a timing chart illustrating the drive method for controlling the transistor 1302 and the transistor 1304, which are transfer transistors, and the reset transistor 1303 to be turned on and becoming conductive/turned off and becoming non-conductive. t41, t42, t43, t44, t45, t46, t47, t48, t49, t410, t411, t412, t413, t414, t415, t416, and t417 indicate timing. Further, the timing t320 illustrated in FIG. 16 is for comparing the present exemplary embodiment with the first exemplary embodiment and is not related to the timing of the operation performed in the present exemplary embodiment. The differences from the first exemplary embodiment will be mainly described below.

At timing t41, all reset transistors 1303 and all row transfer transistors 1302 in the n-th row are turned on. The charges in all PDs 1301 in the n-th row are thus completely transferred to the FDs 1306 so that the PDs 1301 are reset, and all FDs 1306 in the n-th row are reset to the drain potential of the reset transistor 1303.

At timing t42, all row transfer transistors 1302 in the n-th row are turned off. As a result, all PDs 1301 in the n-th row start accumulating the charges.

At timing t43, all reset transistors 1303 and all row transfer transistors 1302 in the (n+1)th row are turned on. The charges in all PDs 1301 in the (n+1)th row are thus completely transferred to the FDs 1306, so that the PDs 1301 are reset, and all FDs 1306 in the (n+1)th row are reset to the drain potential of the reset transistor 1303.

At timing t44, all row transfer transistors 1302 in the (n+1)th row are turned off. As a result, all PDs 1301 in the (n+1)th row start accumulating the charges.

At timing t45, the column transfer transistor 1304 of the column to which the short-time exposure is assigned in the n-th row is turned on. The charge of the PD 1301 in the column to which the short-time exposure is assigned in the n-th row is thus completely transferred to the FD 1306, so that the PD 1301 is reset. Further, the FD 1306 of the column to which the short-time exposure is assigned in the n-th row is also reset to the drain potential of the reset transistor 1303.

At timing t46, the column transfer transistor 1304 of the column to which the short-time exposure is assigned in the n-th row is turned off. As a result, the PD 1301 of the column to which the short-time exposure is assigned in the n-th row starts accumulating the charge.

At timing t47, all reset transistors 1303 and all row transfer transistors 1302 in the (n+2)th row are turned on. The charges in all PDs 1301 in the (n+2)th row are thus completely transferred to the FDs 1306, so that the PDs 1301 are reset, and all FDs 1306 in the (n+2)th row are reset to the drain potential of the reset transistor 1303.

At timing t48, all reset transistors 1303 in the n-th row are turned off, and all row transfer transistors 1302 in the n-th row are turned on. The charge of the PD 1301 that accumulates the light form the object is thus completely transferred to the FD 1306.

At timing t49, all row transfer transistors 1302 in the (n+2)th row are turned off. As a result, all PDs 1301 in the (n+2)th row start accumulating the charges.

At timing t410, all row transfer transistors 1302 in the n-th row are turned off, and the transistor 1305 in the n-th row is turned on. The impedance in the potential of the FD 1306 is thus lowered and the potential is transferred as a pixel output VOUTₙ in the n-th row to the signal line connected to the output circuit 1205. Further, the column transfer transistor 1304 of the column to which the short-time exposure is assigned in the (n+1)th row is turned on. As a result, the charge in the PD 1301 of the column to which the short-time exposure is assigned in the (n+1)th row is completely transferred to the FD 1306, so that the PD 1301 is reset, and the FD 1306 of the column to which the short-time exposure is assigned in the (n+1)th row is reset to the drain potential of the reset transistor 1303.

At timing t411, the column transfer transistors 1304 of the column to which the short-time exposure is assigned in the (n+1)th row is turned off. All PDs 1301 of the column to which the short-time exposure is assigned in the (n+1)th row thus start accumulating the charges.

At timing t412, all reset transistors 1303 in the (n+1)th row are turned off and all row transfer transistors 1302 in the (n+1)th row are turned on. As a result, the charge acquired from the light from the object in the PD 1301 is completely transferred to the FD 1306.

At timing t413, all row transfer transistors 1302 in the (n+1)th row are turned off and all transistors 1305 in the (n+1)th row are turned on. The impedance in the potential of the FD 1306 is thus lowered and the potential is transferred as a pixel output VOUTₙ₊₁ in the (n+1)th row to the signal line connected to the output circuit 1205. Further, the column transfer transistor 1304 of the column to which the short-time exposure is assigned in the (n+2)th row is turned on. As a result, the charges in all PDs 1301 of the column to which the short-time exposure is assigned in the (n+2)th row is completely transferred to the FD 1306 so that the PDs 1301 are reset, and all FDs 1306 of the column to which the short-time exposure is assigned in the (n+2)th row are reset to the drain potential of the reset transistor 1303.

At timing t414, the column transfer transistor 1304 of the column to which the short-time exposure is assigned in the (n+2)th row is turned off. The PD 1301 of the column to which the short-time exposure is assigned in the (n+2)th row thus starts accumulating the charge.

At timing t415, all reset transistors 1303 in the (n+2)th row are turned off and all row transfer transistors 1302 in the (n+2)th row are turned on. As a result, the charge acquired from the light from the object in the PD 1301 is completely transferred to the FD 1306.

At timing t416, all row transfer transistors 1302 in the (n+2)th row are turned off, and all transistors 1305 in the (n+2)th row are turned on. The impedance in the potential of the FD 1306 is thus lowered and the potential is transferred as a pixel output VOUTₙ₊₂ to the signal line connected to the output circuit 1205.

At timing t417, transfer of the pixel output VOUTₙ₊₂ to the signal line connected to the output circuit 1205 ends.

Other configurations and operations are similar to those of the first exemplary embodiment.

According to the second exemplary embodiment, the long-time and short-time exposure are controlled by setting either of the two types of reset timing. Since one row can be readout at once, the time for reading one frame can be shortened. Further, since only one type of control is necessary for controlling the column transfer transistor to be turned on, the load generated and the memory necessary for performing the transistor control process can be reduced. Furthermore, the FD 1306 is always reset to the drain potential of the reset transistor 1303 before the charge of the PD 1301 is completely transferred to the FD 1306. As a result, the noise that may be generated in the FD 1306 during exposure can be removed.

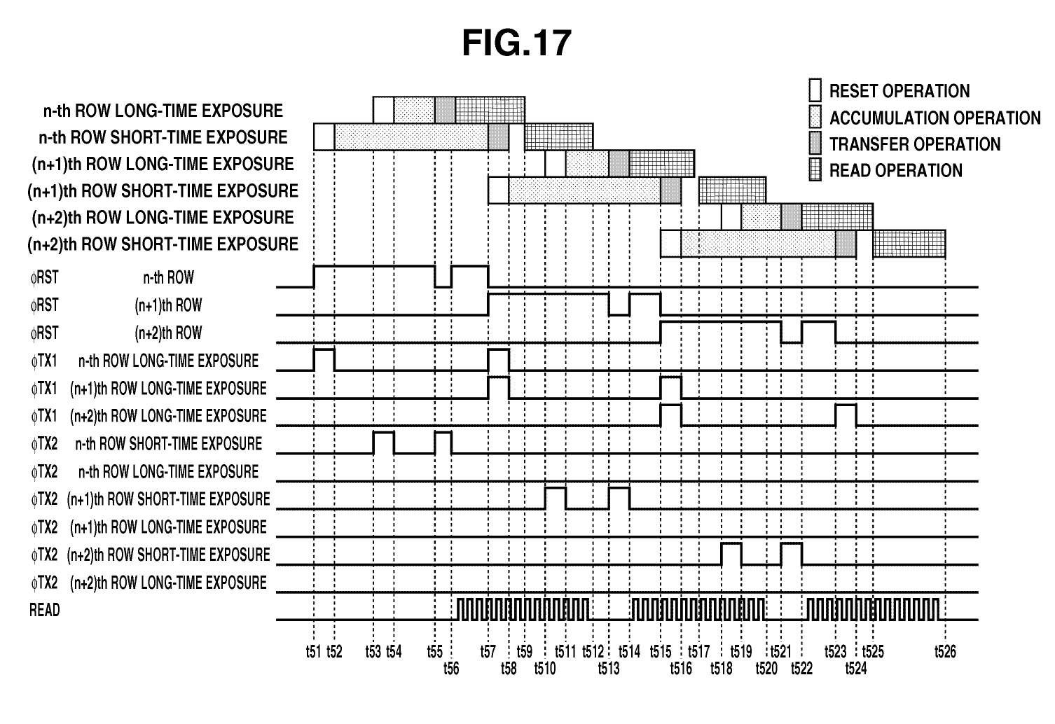

In a third exemplary embodiment of the present invention, the time difference between the long-time exposure and the short-time exposure is reduced by aligning the centers of the long-time exposure and the short-time exposure in terms of time in the line. The long-time exposure and the short-time exposure in which the centers are aligned are controlled by transmitting one of the two types of column transfer pulses to each pixel in each line. In the present exemplary embodiment, the control of the long-time and short-time exposures by aligning the centers is realized by performing either of the two types of reset-read out operation. One type of the of reset-read out operation is a combination of resetting by the row transfer transistor 1302 and the reset transistor 1303 and reading out by turning on the column transfer transistor 1304. The other type is a combination of resetting by the column transfer transistor 1304 and the reset transistor 1303 and reading out by turning on the column transfer transistor 1304. FIG. 17 illustrates a driving method for the pixel 1202 and its characteristic according to the third exemplary embodiment. More specifically, FIG. 17 is a timing chart illustrating the drive method for controlling the transistor 1302 and the transistor 1304, i.e., transfer gates, and the reset transistor 1303 to be turned on and becoming conductive/turned off and becoming non-conductive. t51, t52, t53, t55, t55, t56, t57, t58, t59, t510, t511, t512, t513, t514, t515, t516, t517, t518, t519, t520, t522, t522, t523, t524, t525, and t526 indicate timing. The differences from the first exemplary embodiment will be mainly described below.

At timing t51, all reset transistors 1303 and all row transfer transistors 1302 in the n-th row are turned on. The charges of all PDs 1301 in the n-th row are thus completely transferred to the FD 1306, so that the PDs 1301 are reset, and all FDs 1306 in the n-th row are reset to the drain potential of the reset transistor 1303.

At timing t52, all row transfer transistors 1302 in the n-th row are turned off. As a result, all PDs 1301 in the n-th row start accumulating the charges.

At timing t53, the column transfer transistor 1304 of the column to which the short-time exposure is assigned in the n-th row is turned on. The charge of the PD 1301 of the column to which the short-time exposure is assigned in the n-th row is thus completely transferred to the FD 1306, so that the PD 1301 is reset, and the FD 1306 of the column to which the short-time exposure is assigned in the n-th row is reset to the drain potential of the reset transistor 1303.

At timing t54, the column transfer transistor 1304 of the column to which the short-time exposure is assigned in the n-th row is turned off. The PD 1301 of the column to which the short-time exposure is assigned in the n-th row thus starts accumulating the charge.

At timing t55, the reset transistor 1303 of the column to which the short-time exposure is assigned in the n-th row is turned off, and the column transfer transistor 1304 of the column to which the short-time exposure is assigned in the n-th row is turned on. As a result, the charge of the PD 1301 acquired from the light from the object is completely transferred to the FD 1306.

At timing t56, the column transfer transistor 1304 of the column to which the short-time exposure is assigned in the n-th row is turned off and the transistor 1305 in the n-th row is turned on. As a result, the impedance is lowered in the potential of the FD 1306, and the potential is transferred as a short-time exposure pixel output in the n-th row VOUTₙ_{_{—}}ₛ to the signal line connected to the output circuit 1205. All reset transistors 1303 in the n-th row are then turned on.

At timing t57, the reset transistor 1303 of the column to which the long-time exposure is assigned in the n-th row is turned off and the column transfer transistor 1304 of the column to which the long-time exposure is assigned in the n-th row is turned on. As a result, the charge in the PD 1301 that accumulates the light from the object is completely transferred to the FD 1306. Further, all reset transistors 1303 and all row transfer transistors 1302 in the (n+1)th row are turned on. The charges of all PDs 1301 in the (n+1)th row are thus completely transferred to the FD 1306, so that the PDs 1301 are reset, and all FDs 1306 in the (n+1)th row are reset to the drain potential of the reset transistor 1303.

At timing t58, the column transfer transistor 1304 of the column to which the long-time exposure is assigned in the n-th row is turned off. Further, all row transfer transistors 1302 in the (n+1)th row are turned off. ALL PD 1301 in the (n+1)th row thus start accumulating the charges.

At timing t59, transfer of the short-time exposure pixel output VOUTₙ_{_{—}}_{S} to the signal line connected to the output circuit 1205 ends. Further, the transistor 1305 in the n-th row is turned on. As a result, the impedance is lowered in the potential of the FD 1306, and the potential is transferred as a long-time exposure pixel output of the n-th row VOUTₙ_{_{—}}_{L} to the signal line connected to the output circuit 1205.

At timing t510, the column transfer transistor 1304 of the column to which the short-time exposure is assigned in the (n+1)th row is turned on. The charges of all PDs 1301 of the column to which the short-time exposure is assigned in the (n+1)th row are thus completely transferred to the FD 1306, so that the PDs 1301 are reset, and all FDs 1306 of the column to which the short-time exposure is assigned in the (n+1)th row are reset to the drain potential of the reset transistor 1303.

At timing t511, the column transfer transistor 1304 of the column to which the short-time exposure is assigned in the (n+1)th row is turned off. As a result, the PD 1301 of the column to which the short-time exposure is assigned in the (n+1)th row starts accumulating the charge.

At timing t512, transfer of the long-time exposure pixel output VOUTₙ_{_{—}}_{L} to the signal line connected to the output circuit 1205 ends.

At timing t513, the reset transistor 1303 of the column to which the short-time exposure is assigned in the (n+1)th row is turned off. Further, the column transfer transistor 1304 of the column to which the short-time exposure is assigned in the (n+1)th row is turned on. The charge of the PD 1301 acquired from the light from the object is thus completely transferred to the FD 1306.

At timing t514, the column transfer transistor 1304 of the column to which the short-time exposure is assigned in the (n+1)th row is turned off. Further, the transistor 1305 in the (n+1)th row is turned on. As a result, the impedance is lowered in the potential of the FD 1306, and the potential is transferred as a short-time exposure pixel output of the (n+1)th row VOUTₙ₊₁_{_{—}}_{S} to the signal line connected to the output circuit 1205. Further, all reset transistors 1303 in the (n+1)th row are turned off.

At timing t515, the reset transistor 1303 of the column to which the long-time exposure is assigned in the (n+1)th row is turned off, and the column transfer transistor 1304 of the column to which the long-time exposure is assigned in the (n+1)th row is turned on. The charge of the PD 1301 acquired from the light from the object is thus completely transferred to the FD 1306. Further, all reset transistors 1303 and all row transfer transistors 1302 in the (n+2)th row are turned on. The charges of all PDs 1301 in the (n+2)th row are thus completely transferred to the FDs 1306, so that the PDs 1301 are reset, and all FDs 1306 in the (n+2)th row are reset to the drain potential of the reset transistor 1303.

At timing t516, the column transfer transistor 1304 of the column to which the long-time exposure is assigned in the (n+1)th row is turned off. Further, all row transfer transistors 1302 in the (n+2)th row are turned off. As a result, all PDs 1301 in the (n+2)th row start accumulating the charges.

At timing t517, transfer of the short-time exposure pixel output VOUTₙ₊₁_{_{—}}_{S} to the signal line connected to the output circuit 1205 ends. Further, the transistor 1305 in the (n+1)th row is turned on. The impedance is thus lowered in the potential of the FD 1306, and the potential is transferred as a long-time exposure pixel output of the (n+1)th row VOUTₙ₊₁_{_{—}}_{L} to the signal line connected to the output circuit 1205.

At timing t518, the column transfer transistor 1304 of the column to which the short-time exposure is assigned in the (n+2)th row is turned on. As a result, the charge of the PD 1301 in the (n+1)th row is completely transferred to the FD 1306, so that the PD 1301 is reset, and the FD 1306 in the (n+1)th row are reset to the drain potential of the reset transistor 1303.

At timing t519, the column transfer transistor 1304 of the column to which the short-time exposure is assigned in the (n+2)th row is turned off. The PD 1301 of the column to which the short-time exposure is assigned in the (n+2)th row thus starts accumulating the charges.

At timing t520, transfer of the long-time exposure pixel output VOUTₙ₊₁_{_{—}}_{L} to the signal line connected to the output circuit 1205 ends.

At timing t521, the reset transistor 1303 of the column to which the short-time exposure is assigned in the (n+2)th row is turned off. Further, the column transfer transistor 1304 of the column to which the short-time exposure is assigned in the (n+2)th row is turned on. The charge of the PD 1301 acquired from the light from the object is thus completely transferred to the FD 1306.

At timing t522, the column transfer transistor 1304 of the column to which the short-time exposure is assigned in the (n+2)th row is turned off, and the transistor 1305 in the (n+2)th row is turned on. As a result, the impedance is lowered in the potential of the FD 1306, and the potential is transferred as a short-time exposure pixel output of the (n+2)th row VOUTₙ₊₂_{_{—}}_{S} to the signal line connected to the output circuit 1205. Further, all reset transistors 1303 in the (n+2)th row are turned on.

At timing t523, the reset transistor 1303 of the column to which the long-time exposure is assigned in the (n+2)th row is turned off. Further, the column transfer transistor 1304 of the column to which the long-time exposure is assigned in the (n+2)th row is turned on. The charge of the PD 1301 that accumulates the light from the object is thus completely transferred to the FD 1306.

At timing t524, the column transfer transistor 1304 of the column to which the long-time exposure is assigned in the (n+2)th row is turned off.

At timing t525, transfer of the short-time exposure pixel output VOUTₙ₊₂_{_{—}}_{S} to the signal line connected to the output circuit 1205 ends. Further, the transistor 1305 in the (n+2)th row is turned on. As a result, the impedance is lowered in the potential of the FD 1306, and the potential is transferred as a long-time exposure pixel output of the (n+2)th row VOUTₙ₊₂_{_{—}}_{L} to the signal line connected to the output circuit 1205.

At timing t526, transfer of the long-time exposure pixel output VOUTₙ₊₂_{_{—}}_{L} to the signal line connected to the output circuit 1205 ends.

Other configurations and operations are similar to those of the first exemplary embodiment.

As described above, in the third exemplary embodiment, the start time of the short-time exposure for each pixel can be controlled by turning on the reset transistor and the column transfer transistor during the charge accumulation period. Further, the end time of the short-time exposure for each pixel can be controlled by turning on the column transfer transistor. Furthermore, if both the exposure start time and the exposure end time are controlled, the exposure time can be freely controlled. For example, the control can be performed in which the centers of the long-time exposure and the short time exposure in terms of time are aligned. More specifically, control in which the time intervals between a predetermined reset and a predetermined transfer are matched can be performed. As a result, the time displacement within the same line can be reduced. Further, since only one type of turning-on control is necessary for the column transfer transistor, the load and the memory required in the transistor control process can be reduced.

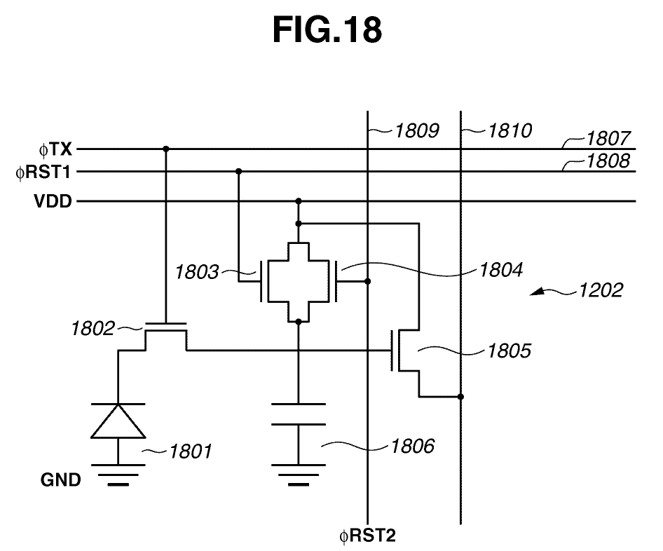

A fourth exemplary embodiment of the present invention will be described below. The configuration of the pixel 1202 and the drive method according to the fourth exemplary embodiment are different from those in the first exemplary embodiment. FIG. 18 is a circuit diagram illustrating an example of the structure of the pixel 1202 according to the fourth exemplary embodiment.

The pixel 1202 includes an embedded PD 1801, which is a light-sensitive element, and N-channel MOS transistors 1802, 1803, 1804, and 1805. An FD 1806 connects to the drains of the transistor 1802 and the transistor 1804 and sources of the transistor 1803 and the transistor 1804. A row selection line 1807, a row signal line 1808, a column selection line 1809, and a column signal line 1810 transmit a signal to each transistor. Further, VDD indicates a power source, and GND indicates grounding. The transistor is turned on and becomes conductive when a high-level (H) signal is supplied to the gate thereof, and is turned off and becomes non-conductive when a low-level (L) signal is supplied to the gate.

The PD 1801 (light receiving unit) accumulates electric charge corresponding to the amount of light input from the object. The accumulated signal charge is output by the row transfer transistor 1802, i.e., the transfer gates, transferring the entire signal charge to the FD 1806. The transferred signal charge is then temporarily accumulated in the FD 1806, which functions as an accumulation unit. Hereinafter, a potential of the row transfer transistor 1302 will be indicated as φTX.

The transistor 1803 is referred to as a row reset transistor, and the FD 1806 is reset to a predetermined potential (φRSB1) by turning on the transistor 1803. The transistor 1804 is referred to as a column reset transistor, and the FD 1806 is reset to a predetermined potential (φRSB2) by turning on the transistor 1804. The reset operation may generate reset noise in which the potential of the FD 1806 fluctuates with respect to φRSB each time the reset operation is performed.

The transistor 1805 is part of a source follower amplifier circuit. The transistor 1805 amplifies the current with respect to a potential VFD of the FD 1806 and lowers the output impedance. Further, the drain of the transistor 1805 is connected to the column signal line 1810, so that the impedance is lowered in the potential, and the potential is transferred as a pixel output VOUT to the column signal line 1810.

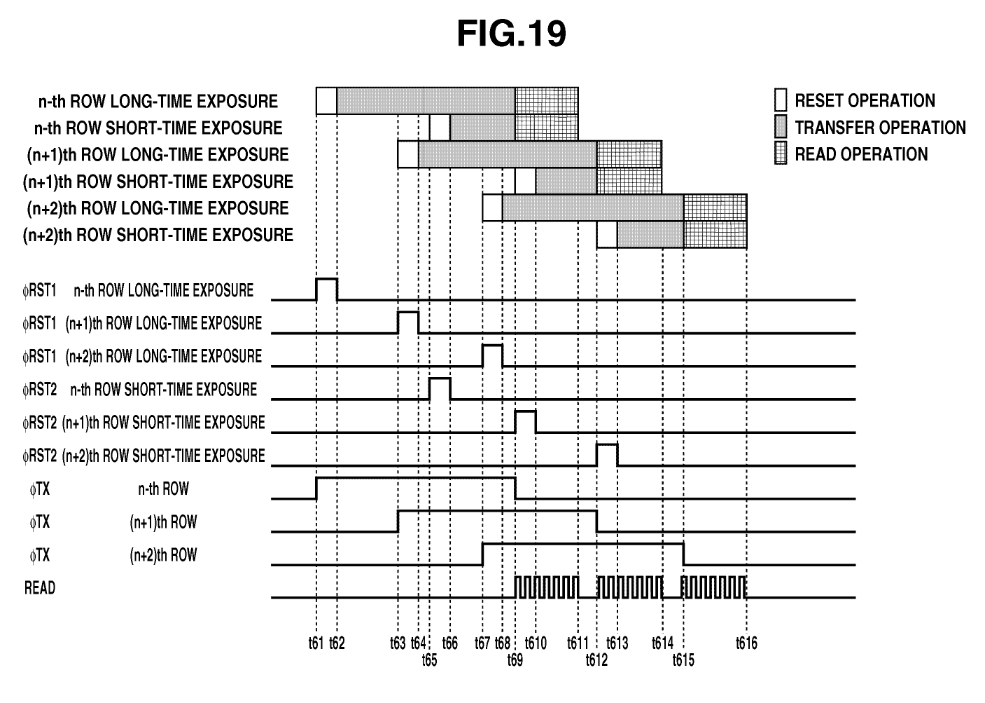

In the present exemplary embodiment, the long-time exposure and the short-time exposure are controlled by setting either of two types of reset timing. One type of timing is a combination of the row transfer transistor 1802 and the row reset transistor 1803. The other timing is a combination of the row transfer transistor 1802 and the column reset transistor 1804. FIG. 19 illustrates a driving method for the pixel 1202 and its characteristic according to the fourth exemplary embodiment. More specifically, FIG. 19 is a timing chart illustrating the drive method for controlling the transistor 1802, the row reset transistor 1803, which are transfer gates, and the column reset transistor 1804 to be turned on and becoming conductive/turned off and becoming non-conductive. t61, t62, t63, t64, t65, t66, t67, t68, t69, t610, t611, t612, t613, t614, t615, and t616 indicate timing.

In the present exemplary embodiment, at timing t61, all row reset transistors 1803 and all row transfer transistors 1802 in the n-th row are turned on. As a result, the charges of all PDs 1801 in the n-th row are completely transferred to the FDs 1806 so that all PDs 1801 are reset, and all FDs 1806 in the n-th row are also reset to the drain potential of the row reset transistor 1803.

At timing t62, all row rest transistors 1803 in the n-th row are turned off. The charges in all PDs 1801 in the n-th row thus start to be transferred to the FD 1806.

At timing t63, all row reset transistors 1803 and all row transfer transistors 1802 in the (n+1)th row are turned on. As a result, the charges of all PDs 1801 in the (n+1)th row are completely transferred to the FDs 1806 so that all PDs 1801 are reset, and all FDs 1806 in the (n+1)th row are reset to the drain potential of the row reset transistor 1803.

At timing t64, all row rest transistors 1803 in the (n+1)th row are turned off. The charges in all PDs 1801 in the (n+1)th row thus start to be transferred to the FD 1806.

At timing t65, the reset transistor 1804 in the column to which the short-time exposure is assigned in the n-th row is turned on. As a result, the charge in the FD 1806 of the column to which the short-time exposure is assigned in the n-th row is reset to the drain potential of the row reset transistor 1803.

At timing t66, the reset transistor 1804 in the column to which the short-time exposure is assigned in the n-th row is turned off. The charge of the column to which the short-time exposure is assigned in the n-th row thus starts to be transferred to the FD 1806.

At timing t67, all reset transistors 1803 and all row transfer transistors 1802 in the (n+2)th row are turned on. As a result, the charges in all PDs 1801 in the (n+2)th row are completely transferred to the FD 1806, so that all PDs 1801 are reset, and all FDs 1806 in the (n+2)th row are reset to the drain potential of the row reset transistor 1803.

At timing t68, all row rest transistors 1803 in the (n+2)th row are turned off. The charges of all PDs 1801 in the (n+2)th row thus start to be transferred to the FD 1806.

At timing t69, all row transfer transistors 1802 in the n-th row are turned off, and the transistor 1805 in the n-th row is turned on. As a result, the impedance is lowered in the potential of the FD 1806, and the potential is transferred as a pixel output VOUTₙ of the n-th row to the signal line connected to the output circuit 1205. Further, the reset transistor 1804 in the column to which the short-time exposure is assigned in the (n+1)th row is turned on. The charge in the FD 1806 of the column to which the short-time exposure is assigned in the (n+1)th row is thus reset to the drain potential of the row reset transistor 1803.

At timing t610, the reset transistor 1804 in the column to which the short-time exposure is assigned in the (n+1)th row is turned off. As a result, the charge in the PD 1801 of the column to which the short-time exposure is assigned in the (n+1)th row thus starts to be transferred to the FD 1806.

At timing t611, transfer of the pixel output VOUT, to the signal line connected to the output circuit 1205 ends.

At timing t612, all row transfer transistors 1802 in the (n+1)th row are turned off, and the transistor 1805 in the (n+1)th row is turned on. The impedance is thus lowered in the potential of the FD 1806, and the potential is transferred as a pixel output VOUTₙ₊₁ of the (n+1)th row to the signal line connected to the output circuit 1205. Further, the reset transistor 1804 of the column to which the short-time exposure is assigned in the (n+2)th row is turned on. The charge in the FD 1806 of the column to which the short-time exposure is assigned in the (n+2)th row is thus reset to the drain potential of the row reset transistor 1803.

At timing t613, the reset transistor 1804 of the column to which the short-time exposure is assigned in the (n+2)th row is turned off. As a result, the charge in the PD 1801 of the column to which the short-time exposure is assigned in the (n+2)th row thus starts to be transferred to the FD 1806.

At timing t614, transfer of the pixel output VOUTₙ₊₁ to the signal line connected to the output circuit 1205 ends.

At timing t615, all row transfer transistors 1802 in the (n+2)th row are turned off, and the transistor 1805 in the (n+2)th row is turned on. The impedance is thus lowered in the potential of the FD 1806, and the potential is transferred as a pixel output VOUTₙ₊₂ of the (n+2)th row to the signal line connected to the output circuit 1205.

At timing t616, transfer of the pixel output VOUTₙ₊₂ to the signal line connected to the output circuit 1205 ends.

Other configurations and operations are similar to those in the first exemplary embodiment.

As described above, according to the fourth exemplary embodiment, the long-time exposure and the short-time exposure can be controlled by providing either of the two types of reset timing, similar to the second exemplary embodiment. Further, since the pixel output VOUT can be transferred at once for one row, the read out time for one frame can be shortened.

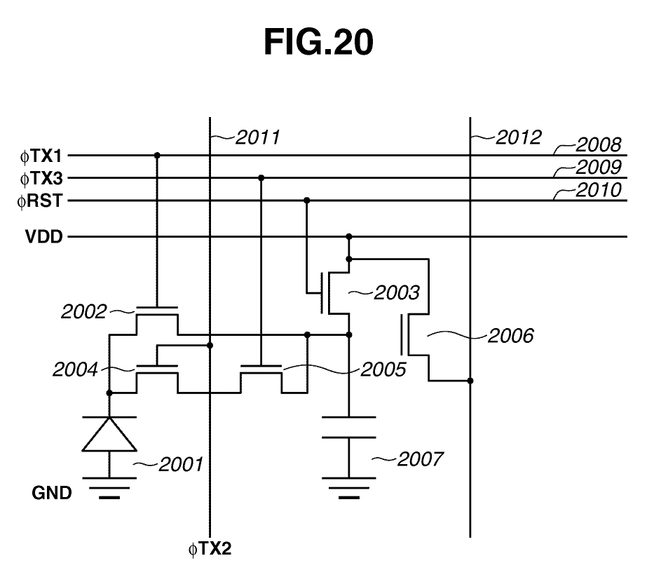

A fifth exemplary embodiment of the present exemplary embodiment will be described below. The configuration and the drive method for the pixel 1202 according to the fifth exemplary embodiment are different from those in the first exemplary embodiment. FIG. 20 is a circuit diagram illustrating an example of the structure of the pixel 1202 according to the fifth exemplary embodiment.

The pixel 1202 includes an embedded PD 2001, which is a light-sensitive element, and N-channel MOS transistors 2002, 2003, 2004, 2005, and 2006. A FD 2007 connects to the drains of transistor 2002 and the transistor 2005 and the source of the transistor 2003. A row selection line 2008, a row signal line 2009, a column selection line 2010, and a column signal lines 2011 and 2012 transmit a signal to each transistor. Further, VDD indicates a power source, and GND indicates grounding. The transistor is turned on and becomes conductive when a high-level (H) signal is supplied to the gate thereof, and is turned off and becomes non-conductive when a low-level (L) signal is supplied to the gate.

The PD 2001 (light receiving unit) accumulates electric charge corresponding to the amount of light input from the object. The accumulated signal charge is output by the row transfer transistor 2002, i.e., the transfer gate, transferring the entire signal charge to the FD 2007, or by the column transfer transistor 2004 and the row transfer transistor 2005 being turned on at the same time. The transferred signal charge is then temporarily accumulated in the FD 2007, which functions as an accumulation unit. Hereinafter, the potential of the row transfer transistor 2002 will be indicated as φTX1, the potential of the column transfer transistor 2004 will be indicated as φTX2, and the potential of the row transfer transistor 2005 will be indicated as φTX3.

The transistor 2003 is referred to as the row reset transistor, and when the transistor 2003 is turned on, the FD 2007 is reset to a predetermined potential (φRST1). The transistor 2006 is part of a source follower amplifier circuit and amplifies the current with respect to a potential VFD of the FD 2007 and thus lowers the output impedance. Further, the drain of the transistor 2006 is connected to the column signal line 2012, so that the impedance is lowered and the signal is transferred as a pixel output VOUT to the column signal line 2012.

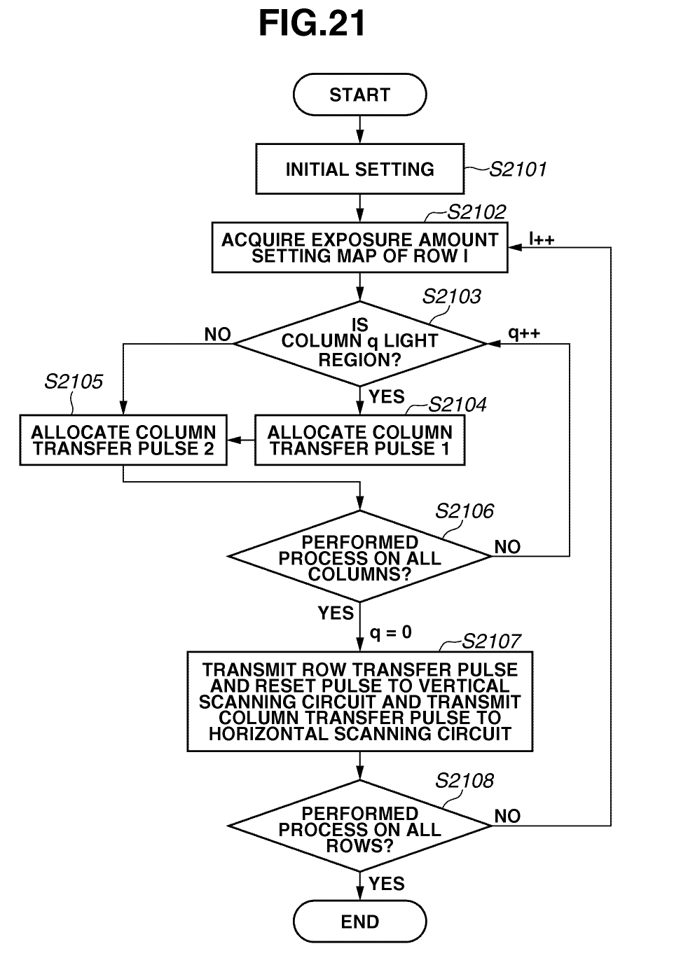

The drive pulse generation process performed in step S804 illustrated in FIG. 8 according to the present exemplary embodiment will be described below with reference to FIG. 21. FIG. 21 illustrates the details of the drive pulse generation process according to the fifth exemplary embodiment.

In step S2101, the timing generator unit 507 performs the initialization process. For example, the timing generator unit 507 sets 0 to both a variable 1, which indicates a row and a variable q, which indicates a column.

In step S2102, the timing generator unit 507 reads all values of the exposure amount setting map of the first row.

In step S2103, the timing generator unit 507 determines whether the shutter speed of the q-th column is the shutter speed of the light region. If the shutter speed of the q-th column is the shutter speed of the light region (YES in step S2103), the process proceeds to step S2104. On the other hand, if the shutter speed of the q-th column is not the shutter speed of the light region (NO in step S2103), the process proceeds to step S2105.

In step S2104, the timing generator unit 507 assigns to the pixel of the q-th column in the first row the drive pulse φTX2 of the column transfer transistor 2004, the drive pulse φTX3 of the row transfer transistor 2005, and the drive pulse φRST of the reset transistor 2003. The drive pulses correspond to the shutter speeds of the light region to be described below. In step S2105, the timing generator unit 507 then assigns to the pixel of the q-th column in the first row the drive pulse φTX1 of the row transfer transistor 2002.

In step S2106, the timing generator unit 507 determines whether the drive pulses have been assigned to all columns in the row. If the drive pulses have been assigned to all columns in the row (YES in step S2106), the timing generator unit 507 sets 0 to the variable q indicating the column. The process then proceeds to step S2107. If it is determined that the drive pulses have not been assigned to all columns in the row (NO in step S2106), the timing generator unit 507 increments the variable q by 1. The process then returns to step S2103.

In step S2107, the timing generator unit 507 generates based on the result of step S2104 or step S2105 the drive pulses of the row transfer transistor 2002, the row transfer transistor 2005, and the reset transistor 2003 to be assigned to the pixel in the first row. Further, the timing generator unit 507 transmits the generated drive pulses to the vertical scanning circuit. Furthermore, the timing generator unit 507 generates the drive pulse of the column transfer transistor 2004 and transmits the drive pulse to the horizontal scanning circuit.

In step S2108, the timing generator unit 507 determines whether the drive pulses have been transmitted to all rows. If the drive pulses have been transmitted to all rows (YES in step S2108), the process ends. If the drive pulses have not been transmitted to all rows (NO in step S2108), the timing generator unit 507 increments the variable 1 indicating the row by 1. The process then returns to step S2102.

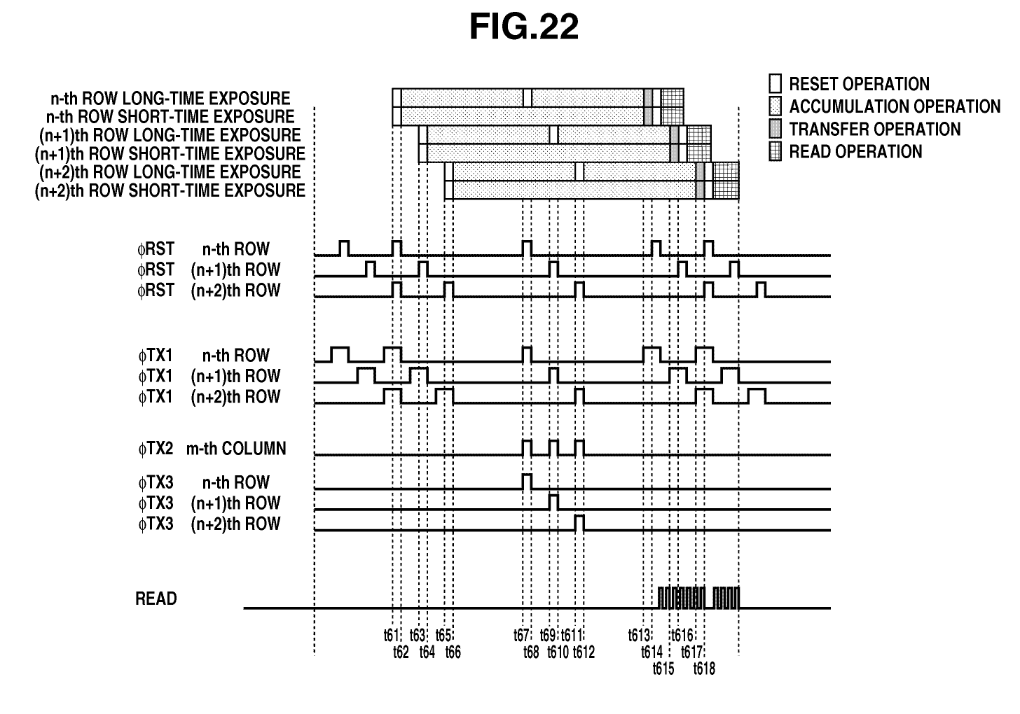

The method for controlling the long-time exposure and the short-time exposure by transmitting two types of the row transfer pulse and the column transfer pulse to each pixel in the line will be described below with reference to FIG. 22. In the present exemplary embodiment, the control of the long-time exposure and the short-time exposure is implemented by providing either of the two types of reset timing. One type of reset timing is a combination of the row transfer transistor 2002 and the reset transistor 2003. The other reset timing is a combination of the row transfer transistor 2005 and the reset transistor 2003. FIG. 22 illustrates a drive method and the characteristic thereof of the pixel 1202 in the fifth exemplary embodiment. More specifically, FIG. 22 illustrates the timing chart of the drive method for controlling the row transfer transistor 2002, the column transfer transistor 2004, the row transfer transistor 2005, and the reset transistor 2003 to be turned on and becoming conductive/turned off and becoming non-conductive. t61, t62, t63, t64, t65, t66, t67, t68, t69, t610, t611, t612, t613, t614, t615, t616, t617, and t618 indicate the timing.

At timing t61, all reset transistors 2003 and all row transfer transistors 2002 in the n-th row are turned on. The charges in all PDs 2001 in the n-th row are thus completely transferred to the FD 2007, so that the PDs 2001 are reset, and all FDs 2007 in the n-th row are reset to the drain potential of the reset transistor 2003.

At timing t62, all row transfer transistors 2002 in the n-th row are turned off. As a result, all PDs 2001 in the n-th row start accumulating the charges.

At timing t63, all reset transistors 2003 and all row transfer transistors 2002 in the (n+1)th row are turned on. As a result, the charges in all PDs 2001 in the (n+1)th row are completely transferred to the FD 2007, so that the PDs 2001 are reset, and all FDs 2007 in the n-th row are reset to the drain potential of the reset transistor 2003.

At timing t64, all row transfer transistors 2002 in the (n+1)th row are turned off. All PDs 2001 in the (n+1)th row thus start accumulating the charges.

At timing t65, all reset transistors 2003 and all row transfer transistors 2002 in the (n+2)th row are turned on. As a result, the charges in all PDs 2001 in the (n+2)th row are completely transferred to the FD 2007, so that the PDs 2001 are reset, and all FDs 2007 in the (n+2)th row are reset to the drain potential of the reset transistor 2003.

At timing t66, all row transfer transistors 2002 in the (n+2)th row are turned off. As a result, all PDs 2001 in the (n+2)th row start accumulating the charges.

At timing t67, all reset transistors 2003 and all row transfer transistors 2005 in the n-th row and the column transfer transistor 2004 in the m-th column to which the short-time exposure is assigned are turned on. As a result, the charge of the PD 2001, which corresponds to the light received from the object, is completely transferred to the FD 2007, so that the PD 2001 is reset.

At timing t68, all reset transistors 2003 and all row transfer transistors 2005 in the n-th row and the column transfer transistor 2004 in the m-th column to which the short-time exposure is assigned are turned off. The PD 2001 thus again starts accumulating the charge.

At timing t69, all reset transistors 2003 and all row transfer transistors 2005 in the (n+1)th row and the column transfer transistor 2004 in the m-th column to which the short-time exposure is assigned are turned on. As a result, the charge of the PD 2001, which corresponds to the light received from the object, is completely transferred to the FD 2007, so that the PD 2001 is reset.

At timing t610, all reset transistors 2003 and all row transfer transistors 2005 in the (n+1)th row and the column transfer transistor 2004 in the m-th column to which the short-time exposure is assigned are turned off. The PD 2001 thus again starts accumulating the charge.

At timing t611, all reset transistors 2003 and all row transfer transistors 2005 in the (n+2)th row and the column transfer transistor 2004 in the m-th column to which the short-time exposure is assigned are turned on. As a result, the charge of the PD 2001, which corresponds to the light received from the object, is completely transferred to the FD 2007, so that the PD 2001 is reset.

At timing t612, all reset transistors 2003 and all row transfer transistors 2005 in the (n+2)th row and the column transfer transistor 2004 in the m-th column to which the short-time exposure is assigned are turned off. The PD 2001 thus again starts accumulating the charge.

At timing t613, all row transfer transistors 2002 in the n-th row are turned on, and the charge of the PD 2001, which corresponds to the light received from the object, is completely transferred to the FD 2007.

At timing t614, all transistors 2006 in the n-th row are turned on. As a result, the impedance is lowered in the potential of the FD 2007, and the potential is transferred as a pixel output VOUTₙ to the signal line connected to the output circuit 1205.

At timing t615, all row transfer transistors 2002 in the (n+1)th row are turned on, and the charge of the PD 2001, which corresponds to the light received from the object, is completely transferred to the FD 2007.

At timing t616, all transistors 2006 in the (n+1)th row are turned on. As a result, the impedance is lowered in the potential of the FD 2007, and the potential is transferred as a pixel output VOUTₙ₊₁ to the signal line connected to the output circuit 1205.

At timing t617, all row transfer transistors 2002 in the (n+2)th row are turned on, and the charge of the PD 2001, which corresponds to the light received from the object, is completely transferred to the FD 2007.

At timing t616, all transistors 2006 in the (n+2)th row are turned on. As a result, the impedance is lowered in the potential of the FD 2007, and the potential is transferred as a pixel output VOUTₙ₊₂ to the signal line connected to the output circuit 1205.

The other configurations and operations are similar to the first exemplary embodiment.

As described above, according to the fifth exemplary embodiment, the timing for turning on either of the two types of a charge transfer path, i.e., the path configured by a first row transfer transistor, or the path in which the column transfer transistor and a second row transfer transistor are arranged in series. Therefore, the long-time and short-time exposure can be controlled for each pixel.

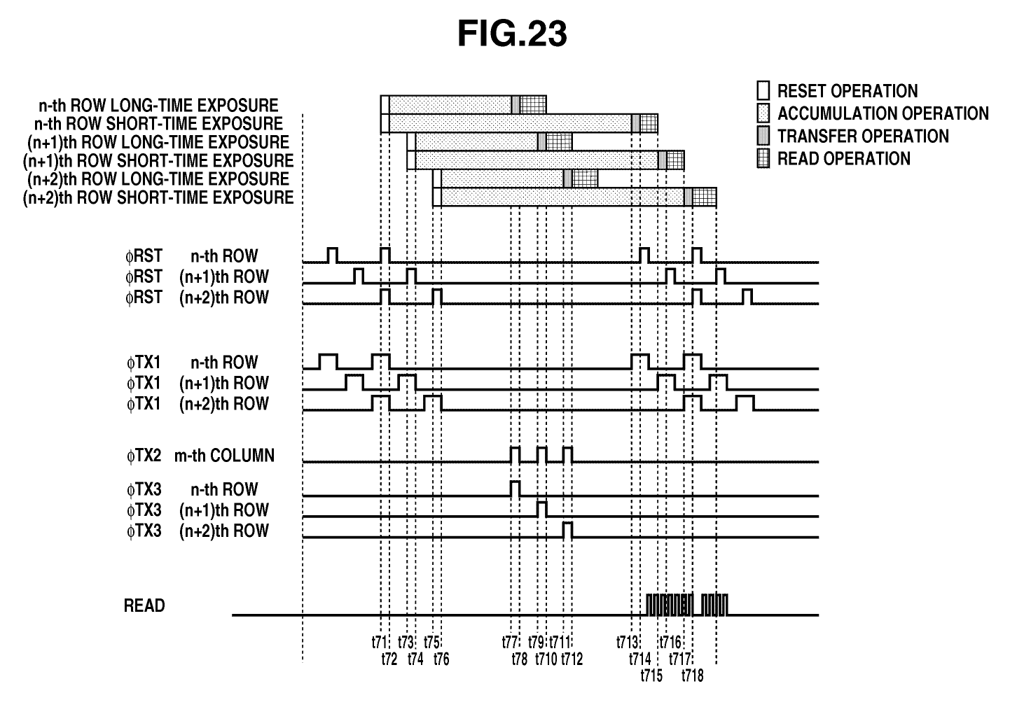

A sixth exemplary embodiment of the present invention aligns the start time of the long-time exposure and the short-time exposure in the pixel circuit configuration described in the fifth exemplary embodiment. The present exemplary embodiment also controls the long-time and short-time exposures by transmitting to each pixel in the line two types of transfer pulses, i.e., the row transfer pulse and the column transfer pulse. The method will be described with reference to FIG. 23, which illustrates a drive method for the pixel 1202 and the characteristic thereof according to the sixth exemplary embodiment. More specifically, FIG. 23 illustrates the timing chart of the drive method for controlling the row transfer transistor 2002, the column transfer transistor 2004, the row transfer transistor 2005, and the reset transistor 2003 to be turned on and becoming conductive/turned off and becoming non-conductive. t71, t72, t73, t74, t75, t76, t77, t78, t79, t710, t711, t712, t713, t714, t715, t716, t717, and t718 indicate the timing.

At timing t71, all reset transistors 2003 and all row transfer transistors 2002 in the n-th row are turned on. The charges in all PDs 2001 in the n-th row are thus completely transferred to the FD 2007, so that the PDs 2001 are reset, and all FDs 2007 in the n-th row are reset to the drain potential of the reset transistor 2003.

At timing t72, all row transfer transistors 2002 in the n-th row are turned off. As a result, all PDs 2001 in the n-th row start accumulating the charges.

At timing t73, all reset transistors 2003 and all row transfer transistors 2002 in the (n+1)th row are turned on. The charges in all PDs 2001 in the (n+1)th row are thus completely transferred to the FD 2007, so that the PDs 2001 are reset, and all FDs 2007 in the n-th row are reset to the drain potential of the reset transistor 2003.

At timing t74, all row transfer transistors 2002 in the (n+1)th row are turned off. All PDs 2001 in the (n+1)th row thus start accumulating the charges.

At timing t75, all reset transistors 2003 and all row transfer transistors 2002 in the (n+2)th row are turned on. As a result, the charges in all PDs 2001 in the (n+2)th row are completely transferred to the FDs 2007, so that the PDs 2001 are reset, and all FDs 2007 in the (n+2)th row are reset to the drain potential of the reset transistor 2003.

At timing t76, all row transfer transistors 2002 in the (n+2)th row are turned off. All PDs 2001 in the (n+2)th row thus start accumulating the charges.

At timing t77, all row transfer transistors 2005 in the n-th row and the column transfer transistor 2004 in the m-th column to which the short-time exposure is assigned are turned on. The charge of the PD 2001, which corresponds to the light received from the object, is thus completely transferred to the FD 2007, so that the PD 2001 is reset.

At timing t78, the transistor 2006 is turned on. As a result, the impedance in the potential of the FD 2007 is lowered, and the potential is transferred as a pixel output VOUTₙ_{_{—}}ₛ to the signal line connected to the output circuit 1205.

At timing t79, all row transfer transistors 2005 in the (n+1)th row and the column transfer transistor 2004 in the m-th column to which the short-time exposure is assigned are turned on. The charge of the PD 2001, which corresponds to the light received from the object, is thus completely transferred to the FD 2007.

At timing t710, the transistor 2006 is turned on. As a result, the impedance in the potential of the FD 2007 is lowered, and the potential is transferred as a pixel output VOUTₙ₊₁_{_{—}}ₛ to the signal line connected to the output circuit 1205.

At timing t711, all row transfer transistors 2005 in the (n+2)th row and the column transfer transistor 2004 in the m-th column to which the short-time exposure is assigned are turned on. The charge of the PD 2001, which corresponds to the light received from the object, is thus completely transferred to the FD 2007.

At timing t712, the transistor 2006 is turned on. As a result, the impedance in the potential of the FD 2007 is lowered, and the potential is transferred as a pixel output VOUTₙ₊₂_{_{—}}ₛ to the signal line connected to the output circuit 1205.

At timing t713, all row transfer transistors 2002 in the n-th row are turned on, and the charge of the PD 2001, which corresponds to the light received from the object, is completely transferred to the FD 2007.

At timing t714, all transistors 2006 in the n-th row are turned on. As a result, the impedance in the potential of the FD 2007 is lowered, and the potential is transferred as a pixel output VOUTₙ_{_{—}}_{L} to the signal line connected to the output circuit 1205.

At timing t715, all row transfer transistors 2002 in the (n+1)th row are turned on, and the charge of the PD 2001, which corresponds to the light received from the object, is completely transferred to the FD 2007.

At timing t716, all transistors 2006 in the (n+1)th row are turned on. As a result, the impedance in the potential of the FD 2007 is lowered, and the potential is transferred as a pixel output VOUTₙ₊₁_{_{—}}_{L} to the signal line connected to the output circuit 1205.

At timing t717, all row transfer transistors 2002 in the (n+2)th row are turned on, and the charge of the PD 2001, which corresponds to the light received from the object, is completely transferred to the FD 2007.

At timing t718, all transistors 2006 in the (n+2)th row are turned on. As a result, the impedance in the potential of the FD 2007 is lowered, and the potential is transferred as a pixel output VOUTₙ₊₂_{_{—}}_{L} to the signal line connected to the output circuit 1205.

Other configurations and operations are similar to the fifth exemplary embodiment.

As described above, according to the sixth exemplary embodiment, the timing for turning on either of the two types of the charge transfer path, i.e., the path configured by a first row transfer transistor, or the path in which the column transfer transistor and the second row transfer transistor are arranged in series. Therefore, the difference in the exposure timing within a row can be reduced by aligning the exposure start time for each pixel within one row.

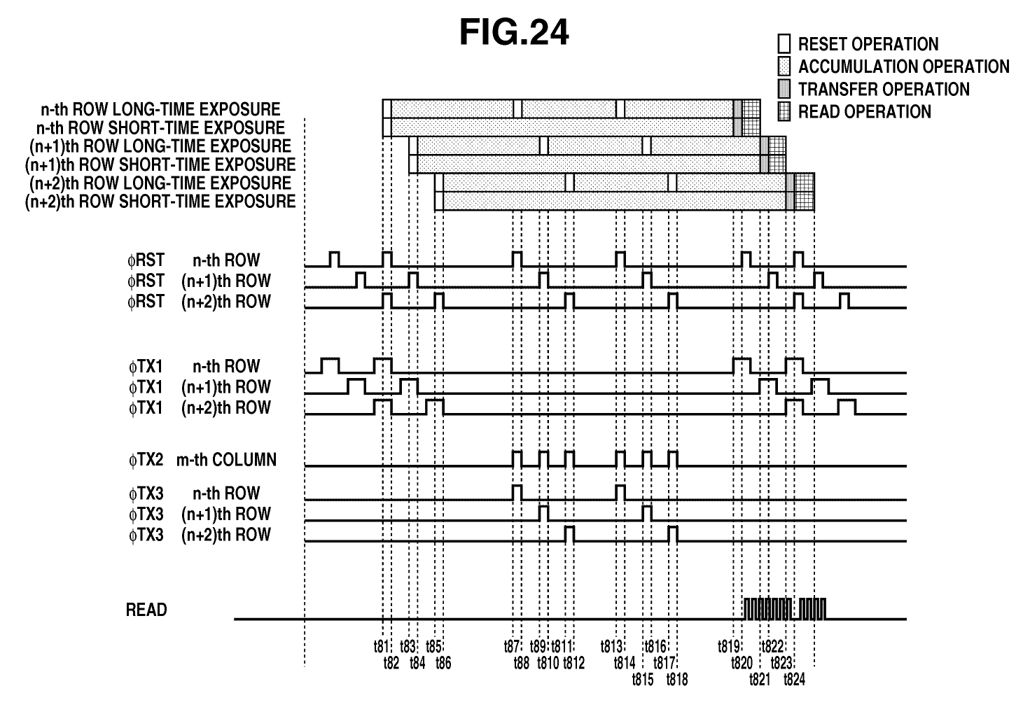

A seventh exemplary embodiment of the present invention controls a plurality of types of the long-time exposure and the short time exposure performed in the pixel circuit configuration described in the fifth exemplary embodiment. FIG. 24 illustrates the drive method for the pixel 1202 and the characteristic thereof according to the seventh exemplary embodiment. More specifically, FIG. 24 illustrates the timing chart of the drive method for controlling the row transfer transistor 2002, the column transfer transistor 2004, the row transfer transistor 2005, and the reset transistor 2003 to be turned on and becoming conductive/turned off and becoming non-conductive. t81, t82, t83, t84, t85, t86, t87, t88, t89, t810, t811, t812, t813, t814, t815, t816, t817, t818, t819, t820, t821, t822, t823, and t824 indicate the timing.

At timing t81, all reset transistors 2003 and all row transfer transistors 2002 in the n-th row are turned on. As a result, the charges in all PDs 2001 in the n-th row are completely transferred to the FD 2007, so that the PDs 2001 are reset, and all FDs 2007 in the n-th row are reset to the drain potential of the reset transistor 2003.

At timing t82, all row transfer transistors 2002 in the n-th row are turned off, and all PDs 2001 in the n-th row thus start accumulating the charges.

At timing t83, all reset transistors 2003 and all row transfer transistors 2002 in the (n+1)th row are turned on. As a result, the charges in all PDs 2001 in the (n+1)th row are thus completely transferred to the FD 2007, so that the PDs 2001 are reset, and all FDs 2007 in the (n+1)th row are reset to the drain potential of the reset transistor 2003.

At timing t84, all row transfer transistors 2002 in the (n+1)th row are turned off, and all PDs 2001 in the (n+1)th row thus start accumulating the charges.

At timing t85, all reset transistors 2003 and all row transfer transistors 2002 in the (n+2)th row are turned on. As a result, the charges in all PDs 2001 in the (n+2)th row are thus completely transferred to the FD 2007, so that the PDs 2001 are reset, and all FDs 2007 in the (n+2)th row are reset to the drain potential of the reset transistor 2003.

At timing t86, all row transfer transistors 2002 in the (n+2)th row are turned off, and all PDs 2001 in the (n+2)th row thus start accumulating the charges.

At timing t87, all reset transistors 2003 and all row transfer transistors 2005 in the n-th row and the column transfer transistor 2004 in the m-th column in which the short-time exposure is assigned are turned on. As a result, the charges in the PDs 2001, which correspond to the light received from the object, are completely transferred to the FD 2007, so that the PDs 2001 are reset.

At timing t88, all reset transistors 2003 and all row transfer transistors 2005 in the n-th row and the column transfer transistor 2004 in the m-th column in which the short-time exposure is assigned are turned off. The PDs 2001 thus again start accumulating the charge.

At timing t89, all reset transistors 2003 and all row transfer transistors 2005 in the (n+1)th row and the column transfer transistor 2004 in the m-th column in which the short-time exposure is assigned are turned on. As a result, the charge in the PD 2001, which corresponds to the light received from the object, is completely transferred to the FD 2007, so that the PD 2001 is reset.

At timing t810, all reset transistors 2003 and all row transfer transistors 2005 in the (n+1)th row and the column transfer transistor 2004 in the m-th column in which the short-time exposure is assigned are turned off. The PD 2001 thus again starts accumulating the charge.

At timing t811, all reset transistors 2003 and all row transfer transistors 2005 in the (n+2)th row and the column transfer transistor 2004 in the m-th column in which the short-time exposure is assigned are turned on. As a result, the charge in the PD 2001, which corresponds to the light received from the object, is completely transferred to the FD 2007, so that the PD 2001 is reset.

At timing t812, all reset transistors 2003 and all row transfer transistors 2005 in the (n+2)th row and the column transfer transistor 2004 in the m-th column in which the short-time exposure is assigned are turned off. The PD 2001 thus again starts accumulating the charge.

At timing t813, all reset transistors 2003 and all row transfer transistors 2005 in the n-th row and the column transfer transistor 2004 in the m-th column in which the short-time exposure is assigned are turned on. As a result, the charge in the PD 2001, which corresponds to the light received from the object, is completely transferred to the FD 2007, so that the PD 2001 is reset.

At timing t814, all reset transistors 2003 and all row transfer transistors 2005 in the n-th row and the column transfer transistor 2004 in the m-th column in which the short-time exposure is assigned are turned off. The PD 2001 thus again starts accumulating the charge.

At timing t815, all reset transistors 2003 and all row transfer transistors 2005 in the (n+1)th row and the column transfer transistor 2004 in the m-th column in which the short-time exposure is assigned are turned on. As a result, the charge in the PD 2001, which corresponds to the light received from the object, is completely transferred to the FD 2007, so that the PD 2001 is reset.

At timing t816, all reset transistors 2003 and all row transfer transistors 2005 in the (n+1)th row and the column transfer transistor 2004 in the m-th column in which the short-time exposure is assigned are turned off. The PD 2001 thus again starts accumulating the charge.

At timing t817, all reset transistors 2003 and all row transfer transistors 2005 in the (n+2)th row and the column transfer transistor 2004 in the m-th column in which the short-time exposure is assigned are turned on. As a result, the charge in the PD 2001, which corresponds to the light received from the object, is completely transferred to the FD 2007, so that the PD 2001 is reset.

At timing t818, all reset transistors 2003 and all row transfer transistors 2005 in the (n+2)th row and the column transfer transistor 2004 in the m-th column in which the short-time exposure is assigned are turned off. The PD 2001 thus again starts accumulating the charge.

At timing t819, all row transfer transistors 2002 in the n-th row are turned on, and the charge in the PD 2001, which corresponds to the light received from the object, is thus completely transferred to the FD 2007.

At timing t820, all transistors 2006 in the n-th row are turned on. As a result, the impedance in the potential of the FD 2007 is lowered, and the potential is transferred as a pixel output VOUTₙ to the signal line connected to the output circuit 1205.

At timing t821, all row transfer transistors 2002 in the (n+1)th row are turned on, and the charge in the PD 2001, which corresponds to the light received from the object, is thus completely transferred to the FD 2007.

At timing t822, all transistors 2006 in the (n+1)th row are turned on. As a result, the impedance in the potential of the FD 2007 is lowered, and the potential is transferred as a pixel output VOUTₙ₊₁ to the signal line connected to the output circuit 1205.

At timing t823, all row transfer transistors 2002 in the (n+2)th row are turned on, and the charge in the PD 2001, which corresponds to the light received from the object, is thus completely transferred to the FD 2007.

At timing t824, all transistor 2006 in the (n+2)th row are turned on. As a result, the impedance in the potential of the FD 2007 is lowered, and the potential is transferred as a pixel output VOUTₙ₊₂ to the signal line connected to the output circuit 1205.

Other configurations and operations are similar to the fifth exemplary embodiment.

As described above, according to the seventh exemplary embodiment, a plurality of types of timing is provided for turning on either of the two types of the charge transfer path, i.e., the path configured by a first row transfer transistor, or the path in which the column transfer transistor and the second row transfer transistor are arranged in series. Therefore, the long-time and short-time exposures of a plurality of types of exposure length of time can be controlled for each pixel within the same row.

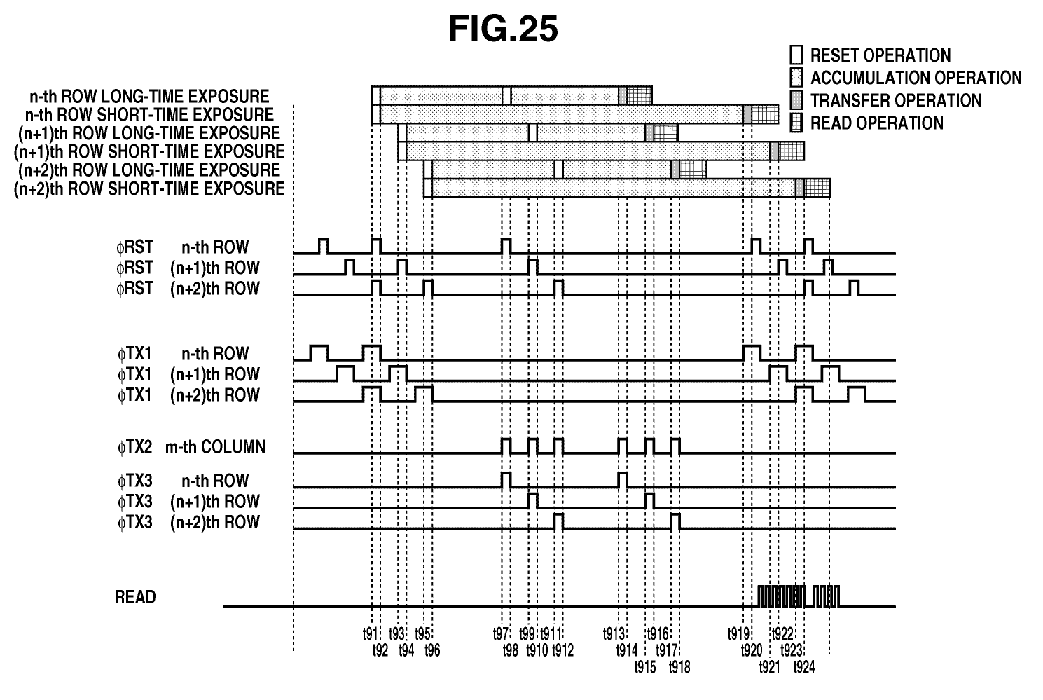

An eighth exemplary embodiment of the present invention controls the long-time exposure and the short time exposure for a plurality of types of exposure length of time for each pixel in the same row of the pixel circuit configuration described in the fifth exemplary embodiment. FIG. 25 illustrates a drive method for the pixel 1202 and the characteristic thereof according to the eighth exemplary embodiment. More specifically, FIG. 25 illustrates the timing chart of the drive method for controlling the row transfer transistor 2002, the column transfer transistor 2004, the row transfer transistor 2005, and the reset transistor 2003 to be turned on and becoming conductive/turned off and becoming non-conductive. t91, t92, t93, t94, t95, t96, t97, t98, t99, t910, t911, t912, t913, t914, t915, t916, t917, t918, t919, t920, t921, t922, t923, and t924 indicate the timing.

At timing t91, all reset transistors 2003 and all row transfer transistors 2002 in the n-th row are turned on. The charges in all PDs 2001 in the n-th row are thus completely transferred to the FD 2007, so that the PDs 2001 are reset, and all FDs 2007 in the n-th row are reset to the drain potential of the reset transistor 2003.

At timing t92, all row transfer transistors 2002 in the n-th row are turned off. As a result, all PDs 2001 in the n-th row start accumulating the charges.

At timing t93, all reset transistors 2003 and all row transfer transistors 2002 in the (n+1)th row are turned on. The charges in all PDs 2001 in the (n+1)th row are thus completely transferred to the FD 2007, so that the PDs 2001 are reset, and all FDs 2007 in the (n+1)th row are reset to the drain potential of the reset transistor 2003.

At timing t94, all row transfer transistors 2002 in the (n+1)th row are turned off, and all PDs 2001 in the (n+1)th row thus start accumulating the charges.

At timing t95, all reset transistors 2003 and all row transfer transistors 2002 in the (n+2)th row are turned on. As a result, the charges in all PDs 2001 in the (n+2)th row are completely transferred to the FD 2007, so that the PDs 2001 are reset, and all FDs 2007 in the (n+2)th row are reset to the drain potential of the reset transistor 2003.

At timing t96, all row transfer transistors 2002 in the (n+2)th row are turned off, and all PDs 2001 in the (n+2)th row thus start accumulating the charges.

At timing t97, all reset transistors 2003 and all row transfer transistors 2005 in the n-th row and the column transfer transistor 2004 in the m-th column in which the short-time exposure is assigned are turned on. As a result, the charge in the PD 2001, which corresponds to the light received from the object, is completely transferred to the FD 2007, so that the PDs 2001 are reset.

At timing t98, all reset transistors 2003 and all row transfer transistors 2005 in the n-th row and the column transfer transistor 2004 in the m-th column in which the short-time exposure is assigned are turned off. The PDs 2001 thus again start accumulating the charge.

At timing t99, all reset transistors 2003 and all row transfer transistors 2005 in the (n+1)th row and the column transfer transistor 2004 in the m-th column in which the short-time exposure is assigned are turned on. As a result, the charge in the PD 2001, which corresponds to the light received from the object, is completely transferred to the FD 2007, so that the PD 2001 is reset.

At timing t910, all reset transistors 2003 and all row transfer transistors 2005 in the (n+1)th row and the column transfer transistor 2004 in the m-th column in which the short-time exposure is assigned are turned off. The PDs 2001 thus again start accumulating the charge.

At timing t911, all reset transistors 2003 and all row transfer transistors 2005 in the (n+2)th row and the column transfer transistor 2004 in the m-th column in which the short-time exposure is assigned are turned on. As a result, the charge in the PD 2001, which corresponds to the light received from the object, is completely transferred to the FD 2007, so that the PD 2001 is reset.

At timing t912, all reset transistors 2003 and all row transfer transistors 2005 in the (n+2)th row and the column transfer transistor 2004 in the m-th column in which the short-time exposure is assigned are turned off. The PDs 2001 thus again start accumulating the charge.

At timing t913, all row transfer transistors 2005 in the n-th row and the column transfer transistor 2004 in the m-th column in which the short-time exposure is assigned are turned on. As a result, the charge in the PD 2001, which corresponds to the light received from the object, is completely transferred to the FD 2007.

At timing t914, the transistor 2006 is turned on. As a result, the impedance in the potential of the FD 2007 is lowered, and the potential is transferred as a pixel output VOUTₙ_{_{—}}_{S} to the signal line connected to the output circuit 1205.

At timing t915, all row transfer transistors 2005 in the (n+1)th row and the column transfer transistor 2004 in the m-th column in which the short-time exposure is assigned are turned on. As a result, the charge in the PD 2001, which corresponds to the light received from the object, is completely transferred to the FD 2007.

At timing t916, the transistor 2006 is turned on. As a result, the impedance in the potential of the FD 2007 is lowered, and the potential is transferred as a pixel output VOUTₙ₊₁_{_{—}}_{S} to the signal line connected to the output circuit 1205.

At timing t917, all row transfer transistors 2005 in the (n+2)th row and the column transfer transistor 2004 in the m-th column in which the short-time exposure is assigned are turned on. As a result, the charge in the PD 2001, which corresponds to the light received from the object, is completely transferred to the FD 2007.

At timing t918, the transistor 2006 is turned on. As a result, the impedance in the potential of the FD 2007 is lowered, and the potential is transferred as a pixel output VOUTₙ₊₂_{_{—}}_{S} to the signal line connected to the output circuit 1205.

At timing t919, all row transfer transistors 2002 in the n-th row are turned on, and the charge in the PD 2001, which corresponds to the light received from the object, is thus completely transferred to the FD 2007.

At timing t920, all transistors 2006 in the n-th row are turned on. As a result, the impedance in the potential of the FD 2007 is lowered, and the potential is transferred as a pixel output VOUTₙ_{_{—}}_{L} to the signal line connected to the output circuit 1205.

At timing t921, all row transfer transistors 2002 in the (n+1)th row are turned on, and the charge in the PD 2001, which corresponds to the light received from the object, is completely transferred to the FD 2007.

At timing t922, all transistors 2006 in the (n+1)th row are turned on. As a result, the impedance in the potential of the FD 2007 is lowered, and the potential is transferred as a pixel output VOUTₙ₊₁_{_{—}}_{L} to the signal line connected to the output circuit 1205.

At timing t923, all row transfer transistors 2002 in the (n+2)th row are turned on, and the charge in the PD 2001, which corresponds to the light received from the object, is completely transferred to the FD 2007.

At timing t924, the transistor 2006 is tuned on. As a result, the impedance in the potential of the FD 2007 is lowered, and the potential is transferred as a pixel output VOUTₙ₊₂_{_{—}}_{L} to the signal line connected to the output circuit 1205.

Other configurations and operations are similar to the fifth exemplary embodiment.

As described above, according to the eighth exemplary embodiment, a plurality of types of timing is provided for turning on either of the two types of charge transfer paths, i.e., the path configured by a first row transfer transistor, or the path in which the column transfer transistor and the second row transfer transistor are arranged in series. Therefore, the long-time exposure and the short time exposure can be controlled for a plurality of types of exposure length of time for each pixel in the same row.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-311439 filed Dec. 5, 2008, which is hereby incorporated by reference herein in its entirety.

What is claimed is:

1. An image capturing apparatus comprising:
an image capturing unit including a plurality of pixels adjacently disposed in a horizontal direction and a vertical direction and configured to perform photoelectric conversion on received light to accumulate electric charge; and
a pixel exposure control unit configured to set an exposure amount of each of the plurality of pixels based on a result of capturing an image by the image capturing unit and to control an exposure time of each of the plurality of pixels.

2. The image capturing apparatus according to claim 1, wherein the image capturing unit is configured to perform at least preliminary image capturing and main image capturing.

3. The image capturing apparatus according to claim 2, wherein the image capturing unit is configured to perform the preliminary image capturing by exposing all of the plurality of pixels with the same exposure time.

4. The image capturing apparatus according to claim 1, wherein the pixel exposure control unit comprises:
an exposure amount map generation unit configured to generate, from an image acquired as a result of image capturing performed by the image capturing unit, an exposure amount map of the plurality of pixels in the image; and
a timing generator configured to generate pixel drive signals that correspond to the exposure amount map.

5. The image capturing apparatus according to claim 4, wherein the exposure amount map generation unit is configured to set at least one of two types of exposure time to each of the plurality of pixels.

6. The image capturing apparatus according to claim 4, wherein the timing generator, based on the exposure amount map, generates reset pulses for resetting charges with respect to all pixels aligned in the horizontal direction, generates row transfer pulses for transferring charges with respect to all pixels aligned in the horizontal direction, and individually generates a column transfer pulse for transferring charge with respect to a pixel aligned in the horizontal direction.

7. The image capturing apparatus according to claim 4, wherein the timing generator, based on the exposure amount map, generates reset pulses for resetting charges with respect to all pixels aligned in the horizontal direction, individually generates a reset pulse for resetting charge with respect to a pixel aligned in the horizontal direction, generates row transfer pulses for resetting charges with respect to all pixels aligned in the horizontal direction, and individually generates a column transfer pulse for transferring charge with respect to a pixel aligned in the horizontal direction.

8. The image capturing apparatus according to claim 4, wherein the timing generator unit, based on the exposure amount map, generates reset pulses for resetting charges with respect to all pixels aligned in the horizontal direction, generates a reset pulse for resetting charge with respect to a pixel aligned in the horizontal direction, and generates row transfer pulses for transferring charges with respect to all pixels aligned in the horizontal direction.

9. The image capturing apparatus according to claim 4, wherein the timing generator unit, based on the exposure amount map, generates a reset pulse, generates a first row transfer pulse corresponding to each exposure time, generates a column transfer pulse corresponding to each exposure time, and generates a second row transfer pulse.

10. An image capturing method using an image capturing apparatus including an image capturing unit including a plurality of pixels adjacently disposed in a horizontal direction and a vertical direction and configured to perform photoelectric conversion on received light to accumulate electric charge, the method comprising:
controlling an exposure time of each of the plurality of pixels based on a result of capturing an image by the image capturing unit; and
performing image capturing using the image capturing unit based on the exposure time.
